(19) United States
(12) Patent Application Publication
(10) Pub. No.: US 2009/0228306 A1
(43) Pub. Date: Sep. 10, 2009

(54) MORTGAGE MANAGEMENT SYSTEM AND METHOD

(76) Inventors: Roman Izyayev, Staten Island, NY (US); John Yalley, Fords, NJ (US)

Correspondence Address: OSTROLENK FABER GERB & SOFFEN, 1180 AVENUE OF THE AMERICAS, NEW YORK, NY, 100368403, US

(21) Appl. No.: 12/328,383

(22) Filed: Dec. 4, 2008

Related U.S. Application Data
(63) Continuation-in-part of application No. 11/496,783, filed on Jul. 27, 2006.
Application No. 11/496,783 is a continuation-in-part of application No. 11/257,172, filed on Oct. 24, 2005, now abandoned.

(51) Int. Cl. G06Q 40/00

(52) U.S. Cl. 705/4

(57) ABSTRACT

Methods and systems for structuring a single financial product that combines mortgage and insurance. Periodic payments of mortgage interest are made during the existence of the mortgage and a guarantee of principal repayment is from an insurance policy at the end of the mortgage term. The proceeds from the insurance policy are reserved to pay the principal on the mortgage. A financial planning product for prospective and active homeowners is provided, and an investment product for individual and institutional investors. Mortgage interest rates for homeowners are reduced over the predetermined mortgage period while maximum financial protection to preserve the home for the family is provided.

### CROSS REFERENCE TO RELATED APPLICATION

This application is a continuation-in-part of U.S. patent application Ser. No. 11/496,783, filed on Jul. 27, 2006 and entitled MORTGAGE MANAGEMENT SYSTEM AND METHOD, which is a continuation-in-part of U.S. patent application Ser. No. 11/257,172, filed on Oct. 24, 2005 and entitled MORTGAGE MANAGEMENT SYSTEM AND METHOD, the entire contents of which are hereby incorporated by reference.

### FIELD OF THE INVENTION

The present invention relates generally to mortgages, and more particularly, to applying proceeds from a life insurance policy to cover the principal amount of a mortgage.

### BACKGROUND

The dream of owning one's own house remains paramount in the minds of many people. Unfortunately, the realities associated with costs associated with a house cause many to never realize that dream.

In particular, the ability for one to obtain a mortgage in order to purchase a house often depends on that person's financial habits, which are tracked by creditors. Lenders simply won't extend credit after determining that the level of risk associated with a borrower is too high. Typically, credit-reporting agencies receive information from various creditors regarding a person's ability and history of paying bills and satisfying various credit allegations. The information received by the credit reporting agencies is then provided to lenders. Lenders use the information to predict the likelihood that a borrower will satisfy payment obligations associated with a mortgage. Thus, a poor credit report can significantly jeopardize a person's ability to obtain a mortgage and purchase a house.

In addition to credit ratings, other impediments prevent people from obtaining mortgages and purchasing a house. For example, many lenders require a significant outlay of capital (i.e., a down payment) that can amount to tens of thousands of dollars. Depending on a purchaser's credit reputation, a down payment can range between 10-30%, or higher, of a house's price. Often, buyers are also required to pay closing costs up front, which can amount to 3-6% of the loan. Thus, requirements for an initial outlay of capital act as an impediment to obtaining a mortgage.

Another impediment to obtaining a mortgage and purchasing a house regards a buyer's capacity with respect to the buyer's income, debt and cash reserves. If a buyer has a significant amount of debt, low cash reserves and low or even no income, even if only temporary, lenders may be unwilling to extend a loan. Thus, a buyer's capacity also can impede the ability to obtain a mortgage and purchase a house.

Another variable considered by lenders is a borrower's collateral, such as real estate, automobiles and capital investments, such as securities, bonds or the like. A borrower with little to no collateral may be unable to obtain a mortgage. Thus, people seeking to obtain a mortgage may be denied for various reasons. Insufficient income, insufficient funds for a down payment, insufficient collateral, poor credit history or the like are often cited reasons for denying a mortgage applicant a loan.

Even for the financially secure, the purchase of a home represents the diversion of equity, i.e., funds on hand, toward a substantial down payment on a home and, over time, to payment of principal on a home in the form of a portion of each monthly mortgage payment. The tying up of those funds in payments of principal on a home, prevents those very same funds from being invested in other types of investments which may yield higher returns.

Many kinds of mortgages are available for prospective borrowers. For example, conventional loans, government loans, fixed rate loans, adjustable rate loans and combinations thereof impose varying types and degrees of conditions on borrowers with respect to required down payments, years to repay, amounts of interest to pay or the like. In a fixed rate mortgage, the interest rate and mortgage monthly payments remain fixed for the period of the loan. For example, fixed rate mortgages are available for thirty, twenty-five, twenty, fifteen and ten year spans. In general, the shorter period of time for a loan, the lower the interest rate the borrower has to pay. The advantage to an extended loan, such as a thirty-year loan with a relatively high interest rate is that monthly payments are typically lower than they would be on a shorter-term loan. Thus, a borrower who can afford a higher monthly payment can save tens of thousands of dollars by obtaining a fifteen-year fixed rate mortgage as opposed to a thirty-year fixed rate mortgage. Other types of loans are available such as balloon loans (requiring fixed monthly payments with a lump sum payment at the end of the mortgage term), adjustable rate mortgages (a mortgage having an interest rate and monthly payments that fluctuate over the life of the loan) and hybrid loans (combination of fixed and adjustable rate mortgage loans) provide varying options for borrowers, depending upon a borrower's financial circumstances.

Notwithstanding the various types of mortgage loans available for consumers, a prospective borrower with a poor credit history, low income and little or no collateral is likely to be denied a mortgage, or else forced to pay a high down payment and accept poor borrowing terms.

### SUMMARY

A combination of mortgage interest only and life insurance premium payment is provided in one or more products. The product is structured to have the loan principal to be equal to the life insurance death benefit and to have enough cash value build up to cover the mortgage principal in a set period. This ensures that enough cash is accumulated in the insurance policy to pay off the mortgage at the end of the mortgage term. Further borrowers may be required to periodically pay interest only on the mortgage to the mortgage company and premium to the insurance company. Moreover, the amount that would have been used to pay principal on the mortgage is preferably used to pay life insurance policy premium.

In a preferred embodiment, a contract gives the lender the right to foreclose on the property, in case of default of mortgage interest payment or insurance premiums. Accordingly, the mortgage property is the collateral for the mortgage. Further, cash value accumulates from premium payments and interest credited to the policy by the insurance company. The interest preferably stays in the policy. Moreover, a borrower may borrow against cash value of the insurance policy subject to underwriting.

Preferably, the mortgage principal amount is paid with life insurance proceeds, which is the cash value at the end of mortgage term, or death benefits in case of the borrower's death. The cash value in the whole life policy preferably acts as a guaranteed amortization of the mortgage loan. When the cash value matches the loan amount (i.e., the outstanding mortgage principal), the mortgage is paid off and the homeowner may terminate the life insurance.

Preferably, cash value does not reduce mortgage principal amount, i.e., the amount used to calculate the mortgage interest payments.

If property is refinanced, the borrower can transfer the insurance policy beneficiary to the new lender. In case the property is sold before the end of mortgage term, the borrower can either close the mortgage out or transfer it to a new property and the new lender becomes the new beneficiary of the policy. That is, the cash value accumulated in the policy can either be used to pay off the principal amount of the mortgage or maintained for the benefit of the new lender.

Further, a disability waiver for the premium can be extended to cover interest payments on the mortgage. Also, a dividend option can be used either to reduce premium payment or to increase cash value. Monthly required payment is calculated and compared with the premium payment in order to ensure that the policy is adequately funded monthly. The required payment is the amount of premium that must be paid until the mortgage term in order to accumulate enough cash value to pay off the mortgage principal at the end of term. This is preferably for variable rate policies.

If the required payment is greater than the premium amount for a variable life insurance due to investment losses or lower investment returns, the borrower is preferably required to make the required payment instead of the premium payment.

Although the life insurance policy cash value may fluctuate in response to investment experience, the required payment ensures that proceeds of the insurance policy is sufficient to cover the principal balance on the mortgage.

Various policies are useable to fund a mortgage, including permanent (whole life, universal life, variable universal life), term or a combination thereof.

Further, a protection of investments by life-insurance backed mortgage obligations generates investor interest in insurance-funded mortgages, and facilitates trading of securitized mortgages backed by life insurance pools.

Other features and advantages will become apparent from the following description, which refers to the accompanying drawings.

### BRIEF DESCRIPTION OF THE DRAWINGS

For the purpose of illustration, there is shown in the drawings a form which is presently preferred, it being understood, however, that the invention is not limited to the precise arrangements and instrumentalities shown. The features and advantages will become apparent from the following description that refers to the accompanying drawings, in which:

FIG. 1 shows an example hardware arrangement in a preferred embodiment;

FIG. 2 illustrates the functional elements of a user terminal and/or information processor;

FIG. 3 illustrates an embodiment comprising a borrower, insurance policy and a mortgage;

FIG. 4 is a block diagram that illustrates an example networked arrangement of parties associated with a preferred embodiment;

FIG. 5 illustrates a portion of an example a mortgage application display screen in accordance with an embodiment;

FIG. 6 illustrates a portion of an example life insurance policy application display screen 600 in accordance with a preferred embodiment;

FIG. 7 is a table showing an analysis of the integrated mortgage-insurance product in accordance with an embodiment;

FIG. 8 is a table that shows a summary of average revenue and profit for an insurance company in an example market situation in accordance with an embodiment;

FIG. 9 is a table that shows a summary average incremental revenue and profit for the mortgage company in accordance with an example market situation in accordance with an embodiment;

FIG. 10 shows three tables regarding the integrated mortgage-insurance product, and indicates substantial gain to the financial institution holding, a mortgage banking company and a life insurance company;

FIGS. 11A and 11B are graphs illustrating the relationship between mortgage interest rate and home purchases in the prior art;

FIGS. 12A and 12B are bar graphs illustrating insurance-funded mortgage product benefits in accordance with a preferred embodiment;

FIG. 13 is a figure illustrating an insurance-funded mortgage operation that combines mortgage and insurance operations; and

FIG. 14 is a figure that illustrates an insurance-funded mortgage information technology infrastructure that consolidates mortgage and insurance in a system application.

### DETAILED DESCRIPTION OF THE PREFERRED EMBODIMENTS

In accordance with preferred embodiments, methods and systems for managing an integrated financial product, including mortgage and insurance, are provided to generate maximum benefits while simultaneously eliminating or minimizing risks to stakeholders of the financial services industry, including homeowners, investors, banks, and insurance companies. Methods and systems are further provided for a single financial vehicle that guarantees the return of a predetermined amount of investment returns, while also ensuring protection of principal. In accordance with various embodiments, methods and systems combine a principal preservation component and an interest income component in a single financial vehicle. Accordingly, an investment amount, including periodic payments made by a homeowner, is invested in a single product vehicle, which allocates the amount to the interest income component during the mortgage period, and to the principal component to be paid off at the end of the mortgage period.

Many of the features described herein draw upon modern science of finance to address several important practical issues in personal finance. Among these are home ownership and protection, retirement security, and estate transfer. To address these and other issues, individuals are motivated to commit to financial planning in connection with assessment mechanisms that are provided herein and assist in determining how much to save in order to own and protect a home and how much to save for retirement and how to invest those savings.

Preferably, finance theory is combined with innovations in new product development to improve the financial welfare of an individual and family. New life-cycle strategies, processes, and products are provided in accordance with the teachings herein for the individual and family. The results are in stark contrast with the old fragmentary product models of traditional financial planning, as a new efficient integrated multiple product model is provided that takes account of multi-period risk management, hedging, and habit formation in order to achieve laudable financial goals, mainly home ownership and protection, retirement security, and estate transfer. The integrated financial systems and methods provided herein, through a personal financial planning mechanism, emphasize that it is most rational to plan early.

Adequate financial protection is desirable to reduce or eliminate financial anxieties in the financial industry, particularly in connection with home mortgages. Accordingly, increased financial protection is preferably provided for stakeholders in the financial industry, and, accordingly, a system and method are provided that integrate mortgage and insurance and that assure maximum protections to enable stakeholders achieve their financial goals.

In accordance with an embodiment, a new segment in the financial industry is created, as people are brought into the mortgage and insurance marketplace. Moreover, an efficient management of integrated systems and methods is created, as capital market funds are brought into mortgage and insurance. Accordingly, a planning product, a financial product, and a security product are preferably provided. The financial planning product is preferably a strategy process designed to bring more people into the mortgage and insurance market to substantially increase an insurance pool and maximize protection. The financial product preferably creates a very efficient synergistic system and method for product management, both technologically and operationally, and maximizes profitability. The security product preferably brings a large amount of capital into the new industry by efficiently creating capital flows to the industry through the maximization of protection of capital and the maximization of rate of return on investment. Effectively, an integrated system and method is provided that creates a new industry comprising integrated mortgage and insurance.

Insurance-funded mortgage, in accordance with a preferred embodiment, employs concepts that relate to life insurance and are applied to bring homeowners together in an insurance pool, in order to utilize the power of the homeowners' collective mortality statistics and reduce mortgage interest rates and protect their homes. Additionally, investors are able to utilize the power of the life insurance pool in order to increase investment income, to enable banks to utilize the power of insurance pool to protect investments in mortgage assets, and to enable insurance companies to utilize mortgage funds as additional source of funds to increase capital.

In a preferred embodiment, the financial product, referred to herein, generally, as “insurance-funded mortgage,” integrates a first module that contains information regarding terms of a mortgage. The terms preferably include a principal amount of a mortgage, and an interest rate for the mortgage. A second module contains information regarding terms of an insurance policy that is in existence during the life of the mortgage. The terms of the insurance policy preferably include the total amount of proceeds of the insurance policy, the premium amount to be paid for the insurance policy, and the beneficiary of the life insurance policy. Further a tracking system that tracks interest payments made on the interest of the mortgage and further tracks premium payments made on the premium amount on the insurance policy is provided.

Preferably, alternative financing arrangements are available for prospective borrowers to obtain a mortgage, to purchase a house. In one product, an inextricably intertwined combination of life insurance and a mortgage is provided, for example, for the purchase of a house. Preferably, the insurance-funded mortgage product is funded by unique financial instruments, operated by a consolidated system application, and managed by a consolidated business organization. The financial product is preferably a single financial construct comprising mortgage and insurance features. A funding instrument of the insurance-funded mortgage product preferably operates as a reserve fund that is created by a guaranteed insurance fund, an endowment insurance fund, and/or a cash value insurance fund. The system application is preferably an integrated financial application that operates on a common system chassis. In a preferred embodiment, the management organization is under one senior executive officer of a financial holding company.

In a preferred embodiment, the insurance-funded mortgage product combines mortgage interest and a life insurance premium payment. The mortgage according to the teachings herein is preferably structured to have a loan principal to be equal to the life insurance death benefit, while providing enough cash value buildup to cover the mortgage principal in a set period of time. The insurance-funded mortgage product preferably ensures that a sufficient amount of capital is accumulated in the corresponding insurance policy to pay off the remaining balance on mortgage at the end of the mortgage term. Preferably, the borrower periodically pays to a mortgage company interest only on the mortgage, and to an insurance company the borrower pays an insurance premium. The amount that may have been used to pay principal on the mortgage, such as in a typical prior art mortgage, is preferably used instead to pay the life insurance policy premium.

Preferably, a binding contract in connection with the insurance-funded mortgage product provides a lender with a right to foreclose on a property, such as in case of a default on a mortgage interest payment or a default on payment of an insurance premium. Also, the mortgage property is preferably used as collateral for the mortgage. Cash value preferably accumulates from the life insurance policy premium payments, and interest that is credited to the policy by the insurance company. The interest stays in the policy. In one embodiment, a borrower may borrow against the cash value of the insurance policy subject to underwriting (i.e., evaluation of the mortgaged property and creditworthiness of the borrower, similar to Home Equity Line of Credit (HELOC)).

Preferably, the principal amount of the mortgage is eventually paid off from proceeds from the life insurance, particularly resulting from the cash value at the end of mortgage duration, or from death benefits accruing upon the borrower's death. In this way, the cash value in the life insurance policy preferably functions as a guaranteed amortization of the mortgage loan. In one embodiment and in case the mortgage contract so allows, the outstanding mortgage principal may be paid off before the end of mortgage term once the cash value of the insurance policy matches the loan amount. Moreover, the life insurance policy may continue or may terminate, depending upon the terms in the initial contract.

In a preferred embodiment, the mortgage principal amount is used to calculate the mortgage interest payments, and is not reduced notwithstanding the cash value of the life insurance policy changing over time as payments into the life insurance policy are made. In one embodiment and in case a property is refinanced (i.e., an old mortgage is paid off with a new mortgage having a different, typically, lower interest rate), the borrower can transfer the insurance policy beneficiary to the new lender. Moreover, in case the property is sold before the end of the mortgage term, the borrower may either close the mortgage out or may transfer it to a new property and the new lender effectively becomes the new beneficiary of the policy. Thus, the cash value accumulated in the life insurance policy according to the teachings herein can either be used to pay off the principal amount of the mortgage or be maintained for the benefit of a new lender.

Moreover and in one embodiment, disability, critical illness, and unemployment waiver of premiums may be extended to cover interest payments on the mortgage and premium payment of the insurance. For example, a dividend option of some product type(s) may be used to reduce a premium payment or to increase the cash value of the insurance policy. In such case, a quarterly, monthly or other required payment is calculated and compared with the premium payment to ensure that the insurance policy is adequately funded. Preferably, and in case of a variable rate mortgage policy, the required payment is the amount of premium that must be paid during the mortgage term in order to accumulate enough cash value to pay off the mortgage principal at the end of term.

If a required payment is greater than the premium amount for a variable life insurance mortgage, for example, due to investment losses or lower investment returns, the borrower may be required to make the required payment instead of the premium payment. Although the life insurance policy cash value may fluctuate in response to investment experience, the required payment ensures that proceeds of the insurance policy are sufficient to cover the principal balance on the mortgage. Preferably, permanent life insurance (e.g., whole life insurance, universal life insurance, variable universal life insurance), term life insurance or a combination of the two can be used to fund the mortgage.

In accordance with one embodiment, a mortgagee (i.e., borrower) enters into a life insurance contract and selects a product type and funding mechanism in accordance with personal financial plan, and preferably pays a premium into an insurance trust. The trust is preferably obligated to pay the interest on the mortgage to a mortgage company and to pay an insurance premium into an insurance company reserve fund. In this embodiment, an agreement is entered into between a homeowner and, preferably, a financial holding company that manages the trust and that preferably has banking and insurance affiliates. Payments made by the homeowner are preferably allocated into an interest component and a premium component and made by the trustee, pursuant to the financial agreement, and the trustee disburses payments to the mortgage and insurance affiliates accordingly. An up-front agreement obligates the life insurance trustee to allocate funds to the interest component and the premium component, which effectively represents the principal component of the mortgage agreement. In a preferred embodiment, a financial agreement provides that a portion of payments made by the homeowner will be allocated to an interest component and a premium component of the contract. Preferably, the management of receipts and disbursement to the mortgage and insurance companies and the monitoring of principal/reserve pool are under the direction of the life insurance trustee that is responsible to stakeholders including, for example, homeowners, mortgage investors, banking institutions, and insurance companies.

The homeowner may choose one or more product type(s) in accordance with one or more financial planning objective(s). For example an investor may choose a plurality of product types, e.g., a combination of insurance type, funding type, and a death payment type, including a forfeiture or no forfeiture of cash balance in case of death during the existence of the mortgage. Accordingly, the trustee provides the homeowner with all pertinent information to make informed decisions. The trustee also preferably provides a mortgage investor with information concerning periodic interest income and guaranteed principal. The amount of the homeowner's periodic payments that is allocated to an interest component and a guaranteed principal component is a function of one or more of a particular chosen product type, a respective investment period, available interest rates, a need for periodic interest payments, and the mortgage principal (e.g., 100% thereof) that a mortgage investor seeks to have guaranteed over the investment period.

Preferably, optional features of a life insurance policy include disability, critical illness, and unemployment waivers. The integrated optional features operate to relieve or other remove financial anxieties typically associated with prior art mortgages. By addressing the financial concerns not only of the homeowner, the mortgage investor, the banking institution, and the insurance company, financial apprehension is resolved.

Preferably, methods and systems are provided herein for structuring a financial product to allocate investment and protection in homeownership within a single financial product. Accordingly, a portion of the investment is allocated to pay mortgage interest during a mortgage period, and a portion of the investment is allocated into a principal component guaranteed to investors in mortgage assets. The life insurance pool, which guarantees repayment of the mortgage principal at the end of the mortgage period, is invested by the life insurance company to yield a return sufficient to pay the mortgage principal.

In a preferred embodiment, the funding instrument of the insurance-funded mortgage product includes guaranteed interest from a general account of the insurance company and variable returns from a separate account of the insurance company. Preferably, monitoring of a principal/reserve pool is supervised by the life insurance trustee. According to one product type that is funded by a separate account, the homeowner may not be guaranteed a return. In such case, the product may be tailored, for example, for particular investment needs or requirements of the homeowner, and the financial agreement with the trustee may, accordingly, specify general categories of investments in the managed investment pool of the insurance company separate account. In this embodiment, the value of the cash component is preferably determined by the net asset value of the separate account funds that make up the policy portfolio. The selection of this product option triggers a periodic calculation, preferably quarterly, to determine whether a required payment is required when homeowner account balance at the quarter is less than the balance to fund the principal repayment, given the interest rate of the guaranteed interest option. Also according to this embodiment, the selection of this product option requires the insurance company to channel homeowner periodic payments into a plurality of active investment pools. The payments are preferably allocated to different investment pools according to preference(s) of the homeowner. By reviewing the different product types and their output profiles, a homeowner can choose an appropriate set of product types that will enable the homeowner to achieve one or more financial objectives.

Accordingly, the borrower, preferably via the insurance trustee, is responsible for maintaining the contract, which is a combined mortgage contract and life insurance policy with cash balance account within the contract specifically earmarked for the repayment of mortgage principal at the end of the mortgage duration. The proceeds of the reserve fund of the insurance contract are preferably applied exclusively to the principal of the mortgage. The repayment of the mortgage principal, therefore, results from the homeowner accumulated periodic payment amounts and accumulated interest amounts. The repayment of mortgage principal may include life insurance amount at risk and/or interest build-up if homeowner dies before the end of mortgage term. The combined mortgage/insurance product builds a cash value equal to the mortgage amount at the end of mortgage term, or, alternatively, more than a sufficient cash base to cover the mortgage amount for savings and retirement purposes.

Preferably, the insurance-funded mortgage product according to the teachings herein can be structured to be any form of life insurance and an appropriate funding instrument, such as fixed or variable, and the types of funding mechanism are related to the length of the investment period and the prevailing market conditions at the time of the agreement. The insurance-funded mortgage product provides flexibility to satisfy financial needs and to address the financial concerns of the homeowner. Accordingly, it offers varied product options, some of which are described below.

In accordance with the teachings herein, a plurality of product options is provided to suit varying consumers in opting to purchase a home. Those options include guaranteed insurance mortgage, endowment insurance mortgage, ordinary insurance mortgage, universal insurance mortgage, variable insurance mortgage and a hybrid insurance mortgage. The options represent varying contractual terms and obligations.

A guaranteed insurance mortgage option is designed, for example, for younger homeowners who have limited income. The contract terms in accordance with the guaranteed insurance mortgage product protects the homeowner by using term life insurance and a “side sinking fund,” as known in the art, that accumulates payment and interest build-up to be applied to repayment of mortgage principal at the end of mortgage term. The periodic payments and interest credits and the duration of accumulation of payments and interests within homeowner account of the guaranteed contract are designed to build up sufficient cash balance, through the power of guaranteed interest compounding, to pay off mortgage principal at the end of mortgage term. In this product, the interest rate is preferably fixed and guaranteed by the insurance contract. Since the total account balance of the guaranteed contract is earmarked exclusively to pay off the mortgage principal at the end of the mortgage term, however, there is no savings component and no withdrawal or loan element in the guaranteed insurance mortgage product option. Also, there is preferably no forfeiture of an account balance in the event of death during the existence of the mortgage. Accordingly, the death benefit includes a policy face amount and the current up-to-date account balance. The face amount is preferably paid to the mortgage company to pay off the mortgage principal and the account balance is preferably paid to the beneficiary of the homeowner. Moreover, the guaranteed insurance mortgage option preferably invests premium payments and re-invested interest in the general account of the insurance company. The revenue type for the insurance company is the interest spread, as known in the art, between the general account investment income and the guaranteed rate of interest according to the terms of the contract.

Another option, referred to herein as a term insurance mortgage, is also preferably available and designed for younger homeowners who may have limited incomes. This option protects a homeowner using term life insurance. Unlike the guaranteed insurance mortgage option, the homeowner in this option pays mortgage principal and interest periodically, thereby reducing mortgage principal periodically. Consequently, there is no “side sinking fund.” However, the proceeds of the term insurance policy are earmarked by the contract to pay the remaining outstanding mortgage principal in the event of the death of the insured during the term of the mortgage and the difference between the policy's face amount and the mortgage principal is paid to the beneficiary of the homeowner. In this option, there is no individual cash balance, no savings component and no withdrawal or loan element. The death benefit consists solely of policy face amount. The face amount is first paid to the mortgage company to pay off the outstanding mortgage principal, and then any remainder amount is paid to homeowner's beneficiary. Moreover, the mortgage interest rate of this insurance funded mortgage product type is substantially lower than a comparative traditional mortgage because of the existence of term insurance reserve and surplus backing the mortgage loan. Since the insurance company pledges this group of policies to investors in order to reduce the mortgage interest rate for homeowners, but does not get the benefit of investment income from premiums going into a cash fund, this policy is priced equal to or slightly greater than the guaranteed insurance mortgage option, which is a term policy with a side sinking fund. This option invests premium payments in the general account of the insurance company. The revenue type for the insurance company is principally policy fees embedded in the premium.

The endowment insurance mortgage product option also protects the homeowner using term life insurance and a side sinking fund that accumulates payment and interest build-up to be applied for repayment of the mortgage principal at the end of mortgage term. The interest rate is preferably fixed and guaranteed in accordance with the terms of the insurance contract. Since the total account balance is earmarked exclusively to pay off the mortgage principal at the end of the mortgage term, there is no savings component and no withdrawal or loan element in accordance with the endowment insurance mortgage product option. However and unlike the guaranteed insurance mortgage option, there is preferably a forfeiture of the total account balance in the event of the policyholder's death during the existence of the mortgage. Accordingly, the death benefit preferably equals the policy face amount.

The premium of the endowment insurance mortgage product option is preferably lower than the guaranteed insurance mortgage product option because part of the payoff amount for the mortgage comes from the insurance reserve. The face amount of the policy, at the time of death during the existence of the mortgage, is preferably paid to the mortgage company to pay off the mortgage principal. The account balance remains in the insurance reserve pool and usable to bolster against an adverse mortality experience. The endowment insurance mortgage product option also preferably invests premium payments and re-invested interest in the general account of the insurance company. This revenue is preferably calculated for the insurance company to be interest spread between general account investment income and the guaranteed interest rate according to the terms of the contract.

The ordinary insurance mortgage product option also protects the homeowner, particularly by using permanent life insurance that has a cash value build-up to be used for repayment of the mortgage principal and for purposes of savings and retirement. The interest rate is on the mortgage is preferably fixed and guaranteed by the insurance contract. The insurance may be participating or non-participating in insurance policy dividends. Since the total account balance includes a savings component, a withdrawal or loan in an amount in excess of the required balance at the quarter is permitted. In accordance with a preferred embodiment, the ordinary insurance mortgage product includes a forfeiture of the total account balance in the event of death during the existence of the mortgage. Accordingly, there is a level death benefit that preferably includes solely the face amount of the insurance policy. Because of the savings element, the premium of this product option is preferably higher than the guaranteed insurance mortgage or the endowment insurance mortgage product options. The face amount of the policy at the time of death during the existence of the mortgage is preferably paid to the mortgage company to pay off the mortgage principal, and the account balance preferably remains in the insurance reserve pool to bolster against an adverse mortality experience. The ordinary insurance mortgage product option also preferably invests premium payments and re-invested interest in the general account of the insurance company. Moreover, the insurance company revenue type is preferably interest spread.

The universal insurance mortgage product option also protects the homeowner using permanent life insurance that has a cash value build-up usable for the repayment of the mortgage principal and for savings and retirement purposes. The interest rate is preferably fixed and guaranteed in accordance with the terms of the insurance contract. The insurance may include participating or non-participating in insurance policy dividends. Since the total account balance includes a savings component, a withdrawal or loan of an amount in excess of the required balance at the quarter is permitted. There is preferably no forfeiture of the account balance in the event of death during the existence of the mortgage. Accordingly, there is an increasing death benefit that includes both the policy face amount and the total account balance at the time of death. Because of the savings element and non-forfeiture of the account balance, the premium of the universal insurance mortgage product option is relatively high. The face amount of the policy at the time of death during the existence of the mortgage is preferably usable to pay the mortgage company for pay off of the mortgage principal and the account balance is paid to the beneficiary of the homeowner. The universal insurance mortgage product option also preferably invests premium payments and re-invested interest in the general account of the insurance company. Moreover, the insurance company revenue type is preferably interest spread.

The variable insurance mortgage product option also protects the homeowner using permanent life insurance that has a cash value build-up that is usable for repayment of the mortgage principal and for savings and retirement purposes. The annual returns of the variable insurance mortgage product option are not guaranteed by the insurance contract. Since the total account balance includes a savings component, a withdrawal or loan of an amount in excess of the required balance at the quarter is permitted. However, because the variable insurance mortgage product option includes variable returns, a required payment is triggered during any quarter when the total account balance is lower than the required balance at the quarter. The required balance and the required payments are preferably amounts, given the guaranteed interest rate according to contractual terms, that are expected to accumulate to meet the principal payment at the end of mortgage term. In accordance with a preferred embodiment, the variable insurance mortgage product option does not include a forfeiture of the account balance in the event of death during the existence of the mortgage. Moreover, because of the savings element and non-forfeiture of account balance feature, the premium of the variable insurance mortgage product option is relatively high. The face amount of the policy at the time of death and during the existence of the mortgage is preferably paid to the mortgage company for payoff of the mortgage principal and the account balance is preferably paid to the beneficiary of the homeowner. The variable insurance mortgage product option preferably invests premium payments and re-invested returns in the separate account of the insurance company. Moreover, the insurance company preferably earns fee revenue from under the terms of the variable insurance mortgage product option.

The hybrid insurance mortgage product option also protects the homeowner, particularly by using both term life insurance and permanent life insurance. The interest rate of the sinking fund of the term insurance is preferably guaranteed under contractual terms. The permanent insurance may be funded by either a guaranteed interest rate cash value build-up or variable returns build-up. Since the total account balance includes a savings component, a withdrawal or loan of an amount in excess of the required balance at the quarter is permitted. The hybrid insurance mortgage product option provides a high level of flexibility in order to enable the homeowner to utilize homeownership and protection and to achieve varied financial objectives. Moreover, the hybrid insurance mortgage product option preferably invests premium payments, fixed interest amounts, and variable returns in the general account and/or separate account according to the homeowner preference. Preferably, the insurance company earns both interest spread and fee revenue under the terms of the hybrid insurance mortgage product option.

Irrespective of the particular insurance mortgage product option, a required payment is preferably triggered during any periods, such as a quarter, when the account balance is lower than the required account balance in that particular quarter. Preferably and in all product options, the mortgage lender is the primary beneficiary of insurance proceeds and is a lien holder until the mortgage principal has been paid off, such as via an internal build-up of cash specifically to pay off the mortgage principal in case the homeowner survives to the term of the mortgage. In each preferred insurance mortgage product option, the death benefit is equal to or greater than the mortgage principal. Moreover, in options employing permanent insurance, the cash value that can be withdrawn equals the amount in excess of the required cash balance at the quarter.

The benefits of the insurance-funded mortgage product are many. The product protects homeownership, and reduces or eliminates a risk of foreclosure. The product further provides investors with substantial revenue and protection of capital, while providing affordability of “ownership and protection” to the homeowner. These benefits are preferably derived from lower interest rates and the insurance pool that backs mortgagees. Accordingly, the insurance-funded mortgage product protects the homeowner, the financial institution, and the mortgage lender against threatening life contingencies, such as death, disability, critical illness, and unemployment. In addition to providing substantial stakeholder benefits, the insurance-funded mortgage product reduces homeowner cash outlay, particularly when compared to traditional conventional mortgage. Moreover, the product builds home equity quickly, and more quickly decreases the mortgage loan payoff amount. The insurance-funded mortgage product also earns stable profits on the investment income from insurance premiums.

Therefore, homeowners benefit from reduced expenditures. Investors benefit from enhanced yields and a guarantee of invested principal and an opportunity for principal protection by life insurance pool. The nature of the single financial vehicle according to the teachings herein enables homeowners to reduce total investment outlay and investors to enhance their total yields, beyond those available from traditional mortgage programs.

Furthermore, investors are provided with a unique and innovative financial product, which meets a critical need in the financial marketplace. A relatively safe financial product is provided for homeowners and a relatively safe investment vehicle for investors in mortgage assets that provide relatively higher interest income and a guarantee of principal.

In an embodiment, a new financial planning product is provided and referred to herein, generally, as home ownership and protection strategies. These strategies ensure continuous expansion of the insurance-funded mortgage insurance pool to enable the new insurance-funded mortgage industry to acquire the capability to provide maximum financial protection for all stakeholders all the time.

Home ownership and protection strategies utilize mortgage and insurance as a foundation for personal financial strategies. Millions of individuals with financial plans centered primarily on home ownership and protection can be brought into the insurance-funded mortgage insurance pool. A large number of participating people is preferable for maximizing financial protection in accordance with the teachings herein. Accordingly, home ownership and protection strategies, including the financial planning product according to the teachings herein, captures eligible and prospective homeowners, preferably between the ages of 20 and 30 years old, in order to ensure continuous addition of millions of people to the insurance pool as they reach that age range and acquire affordability.

Preferably, home ownership and protection strategies use integrated mortgage and insurance concepts as a primary instrument in the process of developing and implementing an integrated plan to accomplish an individual's or family's overall financial objectives. According to the strategies, financial goals and objectives are preferably defined and the potent force of home ownership and protection desires is used to develop and implement an integrated plan to accomplish the objectives. As in traditional financial plans, elements include life insurance, property and liability insurance, mutual funds, common stock, bonds, annuities, savings accounts, will, trust, and real estates. Unlike traditional financial plans, however, home ownership and protection strategies employ a concept of integrated mortgage and insurance to achieve home ownership and protection first and then build upon it to achieve other financial goals. In recognition of the early start and integrated mortgage and insurance concepts as the fundamental corner stone of successful financial planning, regular savings and investment are emphasized early and protection of home and protection of other assets and estate from taxes. Financial planning provides an individual with a framework of objective alternatives that identify an opportunity cost associated with each alternative so that the individual can make a more informed and more rational choice among alternatives.

In a preferred embodiment, home ownership and protection strategies include four strategic phases, and each phase correlates with a broad life-cycle period of the individual. The first phase is a pre-acquisition phase and regards a period up to home purchase. The second phase is an ownership and protection phase, and regards a period during the existence of a mortgage. The third phase is a post-acquisition phase, and regards a period after mortgage payoff but before death. The forth phase is a post-death phase, and regards a period when no breadwinner is available or alive. The cash flow required in each phase to meet needs and to achieve goals may be different and, therefore, each phase requires a different strategy that is designed to suit the unique circumstances of the individual and family. In short, there may be more or less component segments depending on the individual profile and objective.

Preferably, home ownership and protection strategies include financial planning models that are based on a financial profile and financial objective of prospective and active homeowners. Due to the large number of people within a respective age and able to afford homeownership within a target market, financial planning models are created that are based on an interplay of determinants of a successful financial plan. Each model is appropriate to a target market, including, for example, a group of people characterized by similar profiles and objectives. Various profiles and objectives are evaluated by financial models to generate financial products, funding mechanisms, and investment instruments that fortify home ownership and protection, while leading to the financial goal of the homeowner within a time horizon of the strategy. Each model preferably assesses variables, such as age, family size, income, needs and objectives, planning horizon, and risk tolerance to maximize home ownership and protection. The models preferably evaluate affordability in relation to objectives, and create models for defined target groups of people. By entering required pertinent information, individuals' profiles and objectives are matched, preferably automatically, to an appropriate financial planning model and, thereafter, customized to fit financial objectives. Financial planning in accordance with the teachings herein makes ownership and protection elements for achieving a respective financial goal. Thus, home ownership and protection is the centerpiece of home ownership and protection strategies.

During respective phases of home ownership and protection strategies, a variety of services is designed to help an individual develop a tax strategy that ensures maximum cash flow with a minimum liability. Thus, home ownership and protection strategies include a fully integrated plan that helps an individual build a comprehensive financial strategy. By providing objective investment and financial management advice for an individual's personalized unique goals and objectives, home ownership and protection strategies help an individual achieve financial success. Aspects of the individual's personal and business profile, from estate liquidity, ownership succession, and buy-sell agreements, to replacement and disability income that can impact future goals are unearthed, analyzed, and monitored. Accordingly, a collaborative wealth accumulation and management strategy is provided. Moreover, the home ownership and protection strategies provide a strategic home ownership and protection management plan that helps an individual protect interests and achieve a sound financial future.

To illustrate with an example, John Doe, a 25 year old male non-smoker, expects to be married by age 30, to purchase a home and start a family by age 35, and expects his income to reasonably increase to enable him to acquire affordability of home ownership and protection by age 35. In addition, he wants to build-up his savings enough to pay 4-year college expenses for two children and ensure a comfortable retirement beginning at age 65. In this scenario, John Doe is assessed to have affordability at a younger age and has three interrelated objectives: home ownership and protection, savings, and retirement security. Since mortality rates are substantially lower at age-25 than at age-35 and there is a reasonable expectation of increasing income with increasing age, ordinary life insurance at age-25, paid-up at age-65, and conversion of the ordinary life insurance to ordinary insurance mortgage product (one product type of insurance-funded mortgage product and described above) at age 35 is advised. A 10-year cash value build-up, which includes prefunding mortgage principal repayment and savings towards college expense and retirement security, is automatically earmarked towards mortgage principal repayment at the end of the mortgage period. In this embodiment, John Doe substantially reduces ownership and protection cash outlay (compared to conventional mortgage plus life insurance) by utilizing the substantially lower mortality charges at age 25 and comparably substantially reduced an insurance-funded mortgage interest rate and substantially lower aggregate interest payments because of the pre-funded substantial down payment in the life insurance cash value account. John Doe achieves total ownership and protection and the ultimate objective of retirement security at least partly due to a substantially decreased aggregate cash outlay, which frees more income for retirement investing. Additionally, retirement security is enhanced because the mortgage is paid off at age 55 (for a 20-year mortgage) or at age 65 (for a 30-year mortgage).

Preferably, a comprehensive financial plan is provided that utilizes home ownership and protection, mortgage and insurance, and utilizes investments to achieve an individual's ultimate financial goal. Home ownership and protection strategies include a process for determining present and future financial goals, and an appropriate strategy to be undertaken to obtain those goals. Since people's goals and desires change with time, home ownership and protection strategies provide a process that is ongoing. Recognizing that the way that people are financially able to reach these goals and the risk they are willing to take to get there may be different, home ownership and protection strategies provide specific strategies that are tailored to the respective, specific, unique condition of the individual or family.

Preferably, home ownership and protection strategies provide a roadmap: an orderly systematic approach of accomplishing an individual's financial objectives using integrated mortgage and insurance product(s) according to the teachings herein. Individuals discover how an integration of mortgage and life insurance enable them to achieve financial goals. Furthermore, home ownership equity build-up and life insurance protection and cash value build-up enable attainment of financial goals, speedily and smoothly. Preferably, integrated mortgage and insurance provide not only a death benefit for beneficiaries, but also a way to satisfy other financial needs. For example, with permanent life insurance, the individual can protect against death, yet plan for life. In addition to valuable death benefits, permanent life insurance contains a cash value element that grows tax-deferred (with no immediate taxes) inside the policy. This cash value can then be accessed through income-tax-free loans and withdrawals that can be used to meet a variety of purposes without jeopardizing home ownership and protection and without jeopardizing faster wealth accumulation.

In a preferred embodiment, relevant quantitative information of an individual is assembled, such as the individual's assets, liabilities, income, expenditures, nature of investments, life and health insurance, employee benefits, tax situation, wills, trusts, and inheritance prospects and relevant qualitative information such as the individual's interest, life-style, attitudes, desires, and family situation. In order to create a solid personal plan, individual information that is acquired through a comprehensive questionnaire is used to depict a clear holistic picture of the individual's current financial condition so as to help the individual understand where he or she is headed and to help prioritize goals. In the gathering of information, the financial planner reviews the individual's financial statements that are needed to develop an accurate assessment of the individual's financial position. These may include, for example, the balance sheet, the income statement, the cash flow statement, and the statement of change in net worth. In addition to financial statements, the financial planner collects information about the individual's insurance policies and coverage, investments, retirement, and other employee benefits and enters pertinent data into the financial planning database, which then uses software to automatically determine the individual's financial profile and to match it to the financial model most closely suitable to the individual. This model is preferably modified to the unique circumstances of the individual.

With the gathered information, the process then continues to help the individual in the formulation of appropriate goals and objectives. In order to probe into pertinent but potentially sensitive and confidential aspects of individual's personal and business life so as to make truthful information forthcoming, a potent desire for home ownership and protection is used to establish a keen bond of trust.

Thereafter, the location of the individual in accordance with the home ownership and protection strategies is determined to analyze the gathered quantitative and qualitative information in relation to home ownership and protection, and in light of the individual's overall objectives. This phase highlights deficiencies to enable the development of an appropriate strategy. The success of a individual in financial planning is influenced by both internal and external forces. Accordingly, these forces are analyzed to determine the best way to reinforce positive forces, while neutralizing negative forces. Internal forces may include, for example, an individual's current and projected financial situation, tolerance for risk, discipline regarding savings and investments, consumption patterns, and financial goals. The external forces include, for example, external factors that have at least some direct or indirect influence on the financial planning process. These may include economic, legal, social, and political factors. Some examples of external forces for a middle-income individual are the economic forces of inflation, interest rates, property, income, and taxes. Legal forces may include the individual's business organization and employee relations. Social and political forces are especially important to risk analysis in investments in a global environment. The financial planner accurately assesses the external environment and forecasts the threats against the individual's goals and the opportunities open to the individual. The purpose of a thorough review is to scrutinize for opportunities and threats that may relate to particular individuals and their particular financial goals.

Using this information, a profile of the individual's priorities and goals or objectives is developed and modified in conjunction with home ownership and protection. Thus, before any step is taken toward analysis and recommendation, information is gathered and a profile developed. The individual's desires are preferably translated into estimated costs, which are evaluated to determine how much of the funding is already in place. Any deficit between the intended goals and objectives and current financial sources is addressed with life insurance, while protecting the home. Life insurance is used not only to fortify homeownership, but also to complete the financing of other family goals and objectives. Accordingly, life insurance is utilized as a personally arranged and collectively financed way of replacing lost income that may potentially affect homeownership and other financial goals of the individual.

In order to provide financial security to an individual's family, a calculation of lump-sum needs at the time of death, such as payoff of mortgage principal, emergency funds that serve as a safety net or shock absorber, and defraying of expenses of the funeral, burial, or cremation and ongoing income needs such as cost of child care and/or education is made. Each individual's needs and objectives are preferably evaluated and the home ownership and protection strategies model appropriate for each individual is then “personalized” to that individual.

Preferably, integrated segments of a potential time horizon are created, and future cash flow up to the time of home purchase (the first segment), including required cash flow during the existence of the mortgage (second segment), and the cash flow after death (the third segment) are projected, and existing sources of income in determining income deficit are deducted. Thereafter, the present values of all those income needs are determined. Aggregate future income needs vis-à-vis home ownership and protection and other financial goals are determined, and translated into funding objectives using funding approaches appropriate for the profile and objective of the individual.

Due to the penchant desire of people to own their homes and protect them, integrating mortgage and insurance as the bedrock of personal financial strategies makes insurance-funded mortgage, the financial product according to the teachings herein, appealing and ensuring continuous purchase of insurance-funded mortgage and expansion of the insurance pool. People will be compelled to purchase insurance if it adequately and economically protects their homes. Therefore, people will accept home ownership and protection strategies as a veritable instrument of achieving financial goals because it leads to virtual home ownership and protection. People will be accepting because the ability to sustain homeownership indefinitely, through total elimination of threats of life's contingencies, enables the homeowner to easily and smoothly achieve other important financial goals. For example, people are able to handle the problem of children's education and retirement security better when homeownership is secured. When the attainment of the most critical goal, home ownership and protection, is assured and secondary and other important goals are easily attainable. Home ownership and protection strategies protects this critical goal by enlarging the aggregate insurance-funded mortgage reserve and surplus in order to obtain maximum protection for all stakeholders all the time.

Moreover, by capturing prospective homeowners relatively early in their lives, otherwise negative attitudes are neutralized against personal financial planning that are destroying people's financial goals. Although incomes of most people in the middle-income group are sufficient to enable them to achieve lifetime financial goals, especially with regard to home ownership and protection, negative financial attitudes psychologically threatens the financial well being of many people. As a result, financial insecurity afflicts many people. In recognition of the failure to acquire financial security and its adverse impact on a family, the teachings herein instill a desired behavior in the younger generation toward satisfying the laudable desire for home ownership and protection. By providing financial knowledge to many people early in their lives, materialistic attitudes that negatively impact financial goals are neutralized. The teachings herein, including home ownership and protection strategies, articulate and highlight the positive impact of initiating financial planning very early by demonstrating how insurance-mortgage funding enables smooth and speedy attainment of financial goals and objectives.

In accordance with the teachings herein, a plurality of financial planning product types is categorized according to financially powerful controlling factors at the core of the respective product types. There are various financial planning product types based on the interplay of varied factors, which are the determinants of successful financial plans. The decision to use a respective product, and the products themselves preferably include varied factor matrices based on, for example, age groups, family sizes, planning horizons, risk tolerance, and financial objectives. The financial planning product types employ different strategies according to the varied profiles and objectives. Further, varied degrees of determinants for successful financial plans include a varied array of financial models for each target market of the financial services industry and, accordingly, create a financial planning model for each financial strategy. As used herein, a financial strategy refers, generally, to a individual-specific process with individual-suitable integrated mortgage, insurance, retirement, and estate planning product types and since each strategy is primarily based on specificities and degrees of profile and objective, one product is not appropriate for all people. For example, what may be appropriate for a young family with a limited income, long horizon, and high risk tolerance may not be appropriate for a middle aged couple with family, comparably shorter time horizon, and low risk tolerance. Although home ownership and protection is one foundation of each strategy, there are major differences in respective strategies due to significant differences in profiles and objectives. Each strategy is a personal financial planning process and at the core of each strategy are home ownership and protection and other financial goals.

A benefit of home ownership and protection strategies in accordance with the teachings herein is that prospective and active homeowners substantially reduce the cost of the endeavor to acquire and protect among most important and desirable life's accomplishment that are indicative of life success, namely home ownership and protection and retirement security. Planning early in life enables the individual to achieve success in life. What seems to be infeasible for many people is inexpensively made feasible by the home ownership and protection strategies and the financial planning strategies, described herein.

Due to the integration of financial concepts underpinning mortgage and insurance, home ownership and protection strategies enable individuals and families to derive enormous benefits from the process of personal financial planning. Further, individuals are provided with goal identification and prioritization, including an objective, rational view of alternative option, and resource allocation. Further, a framework for feedback, evaluation, and control of personal fortunes is provided, and risks are identified, thereby minimizing their effect through a risk management process (described below). By instilling financial discipline and capturing prospective homeowners early in life, the financial literacy is improved and positive attitudes in the younger generation about personal financial planning are instilled.

The systems and methods described herein employ many different approaches for determining an appropriate amount of mortgage and life insurance for any given individual. Relying on information gathered in connection with an individual, such as described herein, mortgage and life insurance needs are determined for a time horizon, for example, including considering specific needs of the individual's dependents, how much capital the individual has already accumulated, and any existing external sources of finance, such as trusts and inheritances, in order to avoid over-insuring or under-insuring the individual. Individuals are preferably encouraged to provide information to ensure accurate models to perform appropriate, accurate, and thorough analysis of their needs. By recognizing home ownership and protection as a life's desire so dear to many people, especially in the middle-income group, and using it as bedrock of achieving all financial goals, a relationship of trust is preferably established between the individual and the financial planner. Trust is achievable because of the importance of home ownership and protection to the individual. Trust also enables the financial planner to acquire complete, accurate, and sensitive information about the individual that are pertinent to achieving the individual's goals.

Although many of the descriptions and examples herein focus on achieving the goal of home ownership and protection, the invention is not so limited. A holistic approach to financial planning is further provided in accordance with the teachings herein. For example, analytic routines continuously assess opportunities and threats of internal and external environmental elements, taking into account many financial conditions. Many segments of an individual's life cycle are analyzed because financial success is dependent on numerous facets, from home ownership and protection in the beginning segments to tax issues and investment strategies, to retirement and estate planning in the latter segments. Home ownership and protection strategies provide a comprehensive approach for financial planning focusing primarily on acquiring home ownership and protection relatively early in an individual's life and before some other financial goal, because the achievement of other financial goals greatly depends thereon. Thus, a broad financial picture is analyzed to generate a written plan that addresses goals and outlines steps to accomplish those goals.

Preferably, a coordinated integrated effort with other advisers, such as accountants and lawyers, is established to identify constraints and limitations, to develop effective resolution to problems, and to formulate an appropriate financial plan in consideration of home ownership and protection, as well as future possibilities, such as achieving secured retirement and establishing a legacy.

An outline plan is preferably created that shows implementation dates and types of actions to be taken, and the products to be purchased towards acquiring or fortifying home ownership and protection and subsequent goals, such as retirement security and estate transfer. Since death of the individual is inevitable, planning for and implementing the ultimate transfer of assets to the individual's family, loved-ones, and/or an organization of the individual's choice is provided, via the home ownership and protection strategies described herein. Moreover, since an estate is part of an individual's financial picture, individuals are preferably guided to transfer assets to the right people.

Preferably, monitoring dates is established in order to ascertain the extent to which results are compatible with initial expectations and to determine whether changing financial and family situations threaten the achievement of home ownership and protection and other financial goals and objectives.

In connection with information gathered in accordance with the teachings herein, a determination is made regarding the type of investor that the individual is, and the types of investments that are suitable for him or her. Specific financial products are evaluated for appropriateness, such as for retirement needs and for steps to be taken to reach a secure retirement. For example, whether an individual's goal is to fund education, save for retirement or long-term healthcare, or merely to coordinate financial and estate plans, a comprehensive road map that will stand the test of time is preferably created. Therefore, comprehensive personal financial planning is provided that includes investment management integrated with management of mortgage and insurance. By depicting the big picture and integrating objectives and goals with the various elements of the strategy, a personal financial plan is designed that prepares the individual for a secure future and protects assets, preferably via home ownership and protection strategies.

Moreover, achieving financial goals through home ownership and protection requires proper planning starting early in the individual's life. The financial planner preferably performs comprehensive reviews in order to ensure that the individual is on track towards addressing needs and achieving his or her life's desires, for example, whether it is early retirement or college education for kids. Through reviews, pertinent data are periodically entered into the individual specific financial model to enable the financial planner and the individual to re-evaluate income, assets, liabilities, insurance coverage, investment portfolio, tax exposure, and estate plan, to re-prioritize financial goals and time frames for achieving them, if necessary, modify strategies to address new financial weaknesses and build on financial strengths. Implementation, monitoring, and periodic modification of the financial strategies to reflect changing goals, time frames, and circumstances are designed to help individual achieve the goals deem important.

Preferably, retirement and estate planning begin at a relatively early stage of the individual's life in accordance with home ownership and protection strategies. In retirement planning, excess of monthly income over investment outlay for home ownership and protection are preferably directed into an individual retirement account, a 401 (k) plan, a Keogh plan, a defined benefit plan, or some other pension or profit-sharing plan to fortify retirement security. Due to the inherent tax deferment of retirement accounts, a small increase in investment return inside a retirement plan can result in tremendous benefits at retirement. As known in the art, estate planning includes building an estate during individual's lifetime, and eventually passing it on to heirs in a form that minimizes income and estate taxes.

Another element of the teachings herein regards risk management. In order to achieve home ownership and protection strategies, as well as to achieve other financial goals, an individual or a family entity (as in any business) must pay due attention to risk management. Acceptable results can be obtained by properly identifying and managing exposure to threatening events that have the potential to destroy goals and objectives during each stage of life cycle. Threatening contingencies, such as a reduction in income due for example to unemployment, property damage, liability loss exposures such as automobile accident, and personal loss exposures such as death and illness or injury must be properly managed in order to avoid severe or catastrophic impact on goals and objectives. Life and health insurance are typically a foremost threatening life contingencies against the achievement of home ownership and protection goals, which are essential to achieving other financial goals such as retirement security and estate transfer, the teachings herein ensure that life, disability, and critical illness insurance are significant elements of personal financial plans.

In a preferred embodiment, risk of loss of life or property exists is offset as a function of the insurance-funded mortgage product to protect against the risk. Disability waivers are preferably used to protect against the loss of a person's ability to earn a living. Moreover, property and casualty insurance are preferably used to protect against an accident and such perils as fire, flood, earthquake and theft. By managing risks appropriately during each respective life cycle period, an individual and family are able to use equity values of homeownership and cash values of life insurance to establish an integrated savings fund, such as for emergencies, education, investment, and retirement purposes while minimizing taxes. In assessing risks, constraints, and limitations of the individual's financial condition, optimal liquidity is determined that enables the individual to avoid unnecessary and harmful debts. This is to free an individual's income for savings and investment.

Through home ownership and protection strategies, individuals accumulate wealth relatively quickly and easily, and establish a program for heirs through an orderly and efficient transfer of property thereto. During the post-ownership stage of the life cycle, an individual's financial condition is analyzed to determine an orderly and efficient way to protect an existing estate in order to reduce cost of estate transfer, an economically efficient way to pay unavoidable transfer costs, and an appropriate way to change the character of estate property in order to make judicious use of assets. The insurance-funded mortgage product plays a vital role in all phases of the life cycle through home ownership and protection strategies.

Home ownership and protection strategies operate as a financial planning component in accordance with preferred embodiments, and instill systematic personal financial planning in people as early as possible in their careers, with an underlying objective of changing negative attitudes towards life insurance. Home ownership and protection strategies involve gathering all financial and sensitive data, analyze these data, and preparing a financial plan for the future and performing periodic review of the plan to change the plan as environment and financial conditions warrant.

Another feature in accordance with the teachings herein regards a security-based product: life insurance backed mortgage obligations. These represent a new group of investment securities that preferably direct substantial capital market funds to mortgages and in to insurance reserves and surpluses. Financial protection is preferably provided to investors while reducing risk exposures. The securities are targeted to the investment community at large including, but not limited to retail investors, endowments, trusts, foundations, directed funds from insurance companies, and other funds.

Preferably, insurance-financed mortgage securitization is provided that includes the packaging and selling of mortgages backed by life insurance pools to investors. Insurance-financed mortgage securitization preferably converts mortgages to life insurance-backed mortgage securities. Liquidity is enhanced in the insurance-financed mortgage market through easy access to the capital markets. Packages of insurance-financed mortgages, and preferably life-insurance backed mortgage obligation security product types, are sold in the capital markets. The primary concept, fundamental to the creation of insurance-financed mortgage securitization, is a utilization of the life insurance pool to back mortgage assets in order to facilitate movement of capital market funds to the new industry. The insurance pools are designed to provide additional substantial default protections to investors. The existence of the life insurance policy or a life policy with disability, critical illness, and unemployment waivers provides substantially more protections to investors than do conventional mortgage securities. Protection of investments by life-insurance backed mortgage obligations generates investor interest in insurance-funded mortgages, and facilitates trading of securitized mortgages backed by life insurance pools. This attracts capital market funds to the new industry and, accordingly, creates investment securities. The life insurance pool backing mortgages also significantly increases the attractiveness of life insurance backed mortgage obligation securities to investors because, as compared to conventional mortgage securities, prepayment risk and default risk are significantly reduced, if not eliminated. Investors are much more protected by life-insurance backed mortgage obligation securities because of the existence of life insurance reserves and surplus backing the mortgages.

Additionally, insurance-financed mortgage securitization simplifies access to capital markets for prospective homeowners and enables them to achieve their respective financial objectives less costly than in the prior art. The attraction of life-insurance backed mortgage obligations to investors provides enhanced access to funds to purchase homes and the comparably lower interest rates arising from significantly reduced prepayment and default risks reduces insurance-financed mortgage interest rates and, therefore, the cost of homeownership. Furthermore, the availability of a large amount of capital market funds considerably increases the supply of mortgage funds to the insurance-financed mortgage market, thus contributing to comparably lower insurance-financed mortgage interest rates. Thus, a premise of life-insurance backed mortgage obligations is an enhancement of access to funds for the new industry and reduction of cost to homeowners.

Preferably, categories of investment instruments are created that are based on factors such as a type of investor, an investor's risk tolerance, expected cash flow type, time horizon, prepayment tolerance, and sensitivity of investor objectives to inflation and interest rates. These and other capital market dynamics are analyzed in conjunction with financial characteristics of various groups of insurance-funded mortgage product types, and evaluated with investment duration, rate of return on investment, and financial protection of comparable treasury securities to determine an appropriate price of life insurance-backed security.

Preferably, the teachings herein categorize insurance-funded mortgage products and match them to the financial profiles of an investment community. The type of insurance reserve backing the mortgage and the predominant age group of the insurance pool are assessed for the extent of protection, prepayment probabilities, mortality probabilities, and expected surplus of the insurance pool at the end of the mortgage duration and to determine an appropriate price and return on investment for each particular investment security backed by a particular insurance reserve or surplus. Based on these criteria, various types of life insurance-backed securities are created.

After insurance-funded mortgage product origination, a securitization department of a financial holding company under the direction of the senior executive in-charge of insurance-funded mortgage division of the company determines which groups of mortgages to hold on company books and which groups to securitize to ensure adequate liquidity for the banking unit of the company. In one embodiment, the liquidity needs of the company are assessed, including how much capital is required for the mortgage assets on company books, and the optimum securitization of mortgages given the financial objective of the company is periodically calculated. Optimum is the volume and amount of mortgage assets on the balance sheet that yields the most returns for the company.

For each type of life-insurance backed mortgage obligations security, the securitization department aggregates mortgage interest payments, packages them into securities paying periodic interest and principal or interest only periodic payments with a principal payment at the end of a specific duration or interest only or principal only periodic payments for a specific duration. In cases of pass-through insurance-funded mortgage cash flows to investors, the investor preferably receives a constant stream of payments each month that is analogous to the stream of income on other fixed-income securities.

Moreover, life-insurance backed mortgage obligation securities are preferably created that can be issued in multiple classes. The pass-through securities are preferably repackaged and placed in a trust off the company's balance sheet, and are backed by the underlying mortgages and life insurance reserves and surplus, which serve as additional collateral for the security. The investor in each collateralized life-insurance backed mortgage obligation class has a sole claim to the cash flows of that class. For example, a $150 million life-insurance backed mortgage obligation pass-through security can be repackaged into three classes—Class A 6% $50 million size coupons paid monthly, Class B 6.5% $50 million size coupons paid quarterly, and Class C 7% $50 million size coupons paid semi-annually. In this embodiment, each class has a guaranteed or fixed coupon. By restructuring the life insurance backed mortgage obligation pass-through securities, the financial holding company can offer investors who buy Class C a high degree of mortgage prepayment and default protections than other classes and than other securities. Thus, in the event of prepayment, the prepayment amount is paid to Class A until it is totally retired, and then to Class B and then Class C. Excess cash flow over and above the promised coupons retires Class A first, followed by Class B. Class C is retired last.

Each month insurance-funded mortgage mortgagee in the insurance-funded mortgages pool pays premium to the insurance-funded mortgages trust, which in turn pays interest only to the banking division and premium to the insurance division. The interest only cash flows are passed to the investment banking division of the financial holding color that issued the collateralized life-insurance backed mortgage obligation security. The investment bank uses the interest only cash flows to pay promised coupon interest to the three classes of life-insurance backed mortgage obligation bondholders. By repackaging insurance funded mortgage cash flows into multiple cash flows and providing extra collateral of life insurance reserves and surpluses, life-insurance backed mortgage obligation security are made more attractive to more and different groups of investors.

A Class A collateralized life-insurance backed mortgage obligation security is designed for investors seeking short-duration mortgaged-backed assets to reduce the duration length of their mortgage-related asset portfolio, but who prefer extra protection against defaults. Insurance-funded mortgage financial products from which life-insurance backed mortgage obligation securities are derived utilize life insurance reserves and surplus to provide the extra protection. Accordingly, this security type is designed for institutions, such as savings banks and commercial banks.

A Class B collateralized life-insurance backed mortgage obligation security, comparably, has more prepayment protection than the Class A security and, therefore, has an expected duration of about 7 to 10 years. Unlike a conventional collateralized mortgage security, life insurance reserves and surplus provide additional protection, thus making this class of collateralized life-insurance backed mortgage obligation security attractive to pension funds, life insurance companies, banks and thrifts.

A Class C collateralized life-insurance backed mortgage obligation security has a long duration, with virtually no prepayment risk and full protection of life insurance reserves and surplus. Preferably, extra protection and a long duration makes this security highly attractive to insurance companies and pension funds seeking long-term duration assets to match their long-term duration liabilities. The Class C collateralized life-insurance backed mortgage obligation security is a near perfect prepayment and default protection investment instrument that will be of great interest to these financial institutions.

Although three classes are used to illustrate the mechanics of collateralized life insurance backed mortgage obligation securities, a host of other classes are possible, such as to correspond to a host of investor profiles in the capital markets. For example a security class is created to accrue the coupon payments within the real estate mortgage investment conduit trust and paid with the principal at the end of the mortgage duration. Similarly, another class is created to accrue coupon payments within the life insurance surplus account of the insurance trustee and the accumulated interest and principal paid to the investors of this class at the end of duration. By segmenting investors into different classes and by restructuring cash flows into forms more valued by different investor clienteles, the financial holding company is enabled to maximize profits while maximizing investor rate of return and minimizing their risk.

Moreover, life-insurance backed mortgage obligation pass-through securities and collateralized life-insurance backed mortgage obligation securities are created directly by linking them to the cash flows on the underlying mortgagees and the life insurance reserves and surpluses backing them. In another embodiment, life insurance-backed mortgage bonds are available, which are designed to remain on the balance sheet of the financial holding company, but the interest and principal payments on the bond have no direct link to the cash flow on the mortgages and the life insurance reserves and surpluses backing the bond. The bondholder preferably has a first claim to a segment of the mortgage assets of the financial holding company, and the reserves and surpluses backing these assets. The financial holding company preferably segregates a group of mortgage assets on its balance sheet and pledges this group and its supporting life insurance reserves and surplus as collateral backing the bond issue. The reserves and the surpluses provide excess collateral backing the bond. The security is designed to use priority rights and to utilize life insurance backed excess collateral to ensure that a life insurance-backed mortgage bond is accorded high credit rating, such as AAA. Unlike conventional mortgage-backed bonds, there is no need to over-collateralize in order to acquire high credit rating to reduce issue cost because of the inherent extra protections from the existence of supporting pools of life insurance reserves and surpluses.

Alternatively, interest-only life insurance-backed bonds are created with cash flow that reflects the monthly interest payments that are received from a pool of mortgages. The principal payment at the end of the mortgage period reflects the accumulation of monthly principal payments and interest thereon in the life insurance reserve. In case of default, for example, due to abandonment of property, mortgage principal is preferably paid from the supporting life insurance surplus. The life-insurance backed mortgage obligation securities provided in accordance with the teachings herein are attractive for thrifts and banks as an on-balance-sheet hedging vehicle.

In another embodiment, pool of mortgages is split into two classes for groups of investors. One class preferably has a claim only on specific monthly interest-only payments from homeowners, and a second class on specific principal payments into the life insurance reserve that are earmarked to pay mortgage principal at the end of the mortgage duration. The interest-only payment class is ideal for thrifts and banks as an on-balance-sheet hedging vehicle, and the principal-only payment class is ideal for financial institutions that wish to increase the interest rate sensitivity of their portfolios and to investors or traders who wish to take a naked or speculative position regarding the future course of interest rates. Moreover, this security is useful to hedge funds as an instrument to neutralize high and complex sensitivity of their portfolios to interest rates.

Moreover, life insurance backed mortgage obligation securities in accordance with the teachings herein address investor anxieties about prepayment risk. Prepayment risk that afflicts conventional mortgage securities is virtually eliminated by life-insurance backed mortgage obligation securities, at least in part because portability of insurance-funded mortgage contract and interest rates are lower than conventional mortgage interest rates. Moreover, a homeowner is preferably permitted to transfer insurance funded mortgage contract to another home, for example, in cases of relocation. Also, interest rates are substantially lower than conventional mortgage interest rates, thus eliminating refinancing of mortgage, which triggers prepayment. Insurance-funded mortgage interest rates are significantly lower than in a conventional mortgage because significant prepayment and a default risk premium that are inherent to the pricing of conventional mortgages and paid by mortgagees are virtually removed in the pricing of insurance-funded mortgage.

Moreover, prepayments create a potential timing risk, because investors do not know when their bonds will be repaid and their future interest payments eliminated. Frequent fluctuations of high interest rates in conventional mortgages increases a propensity to prepay, and coupons/cash flows realized on mortgage securities can often deviate substantially from stated or expected coupon flows thus compelling some investors to avoid these instruments. These propensities are neutralized in accordance with the teachings herein by creating a stable but significantly lower mortgage interest rate environment using pricing to eliminate refinancing, the primary cause of prepayment. Thus, mortgage pricing and the protection of life insurance reserves and surplus are used to reduce life-insurance backed mortgage obligation mortgage interest rates. The creation of life-insurance backed mortgage obligation financial product creates a virtual no-default and no-prepayment world for investors. Therefore, life-insurance backed mortgage obligation securities pose virtually no risk because portability and lower interest rates virtually eliminate refinancing, and reserves and surplus eliminate default, thus making the securities more attractive to all groups of investors. Insurance-funded mortgage virtually removes not only default risk due to the existence of life insurance reserves and surplus, but also removes prepayment risk because of substantially lower probabilities of refinancing.

Due to contract portability, comparatively lower mortgage interest rates of insurance-funded mortgages, the guarantees of life insurance reserves and surpluses, and reinsurance, the estimated average lives of securities derived from insurance-funded mortgages are expected to vary far less, and more rarely, than typical, prior art mortgage securities. Unlike typical, prior art mortgage securities, whose prepayment experience fluctuates with changes in interest rates, prepayment of the life insurance-backed mortgage securities varies according to mortality and other changes in the status of the insurance policy such lapses and defaults. Since these contingencies are adequately handled by reserve, surplus, and reinsurance, prepayment do not pose a problem to investors. Refinancing and, therefore, prepayment risk is virtually eliminated. In the event of prepayment, market conditions are analyzed to determine whether to pay investors or whether to put the extra amount into the insurance reserve or surplus earmarked to pay mortgage principal at the end of the mortgage duration. Prepayments directed to the insurance reserve or surplus retains the interest income to the insurance company and to investors that would otherwise have been lost in a traditional mortgage prepayment.

Moreover, investor anxieties about default risks are addressed appropriately through the life insurance component of the integrated insurance-funded mortgage product. In the traditional mortgage industry, home abandonment and lax lending are common problems that cause security defaults and financial loss for investors. These problems are highly unlikely in the insurance-funded mortgage industry. It is inconceivable that, in the insurance-funded mortgage industry, people will walk away from a home when they have life insurance protection of their family or when such an action puts substantial cash value at risk. Since most people (about 74% of Americans according to information provided by HUD) have a great desire to own and protect their homes, home abandonment under insurance-funded mortgage products are extremely rare. Moreover since it is inconceivable that originators of insurance-funded mortgages will adopt a strategy of substandard lending since that will put partner or affiliated insurance company life insurance reserves and surpluses at risk, default of insurance-funded mortgages will be very rare. An affiliate or partner insurance company of the bank will be compelled to ensure mortgage creditworthiness. For these reasons, insurance-funded mortgage securities will provide much more protections to investors than traditional mortgage securities.

Turning now to the financial holding company, in one embodiment the financial holding company may elect to hold all mortgage assets on its books using the accumulated insurance surplus to bolster the total capital requirements of the company. In this embodiment, the company retains all interest income from origination of insurance-financed mortgage, thus increasing profitability without endangering the bank's liquidity and without endangering the company's capital base. The company is preferably also choose to hold all securitized insurance-financed mortgages on its books using the corresponding reserves and surplus to back the securities thus enhancing liquidity without endangering capital.

In accordance with the teachings herein, each life insurance backed mortgage obligations security guarantees an investor timely payment of interest and ultimate payment of principal at the calendar date promised. Each securitized insurance-funded mortgage is preferably supported by a well-capitalized base of years of accumulated life insurance surplus. Thus, systems and methods are preferably created that will eventually enable the financial holding company to rely on its own resources, i.e., accumulated life insurance surpluses, instead of guarantees of government sponsored enterprises, to maintain the liquidity of the insurance-funded mortgage market and to expand the number of mortgages to large number of people, including those in low income groups. Accordingly, the financial holding company is empowered to compete equally with government sponsored enterprises, including third-party secondary market lenders, or to replace them as guarantors of securitized mortgages. This is at least in part due to years of accumulated life insurance surplus pools provided in accordance with the teachings herein. The existence of accumulated surplus provides guarantees for the timely payment of mortgage principal and interest, thereby reducing the risks for life insurance-backed mortgage securities for investors. The surpluses offer additional guarantees against default risk by guaranteeing that the principal and the interest of insurance-funded mortgage will be paid. The financial holding company will not require insurance for a mortgage because the mortgage will be adequately insured by reserves and surpluses of life insurance. Thus, the capability of the financial holding company to achieve full self-protection of mortgage assets on its balance sheet and to insure other mortgage assets of other financial institutions for a fee is made highly feasible.

As noted herein, an life insurance reserve and accumulated insurance surplus are created for each insurance-funded mortgage product type to support life insurance backed mortgage obligations securities derived from them. The reserve and the surplus serve as additional collateral to the securities, in addition to the mortgage properties, thus providing extra protection to investors in case of default. In case of untimely death, the reserve is available to pay off the outstanding principal. In case of property abandonment, the surplus is available to pay off the outstanding mortgage principal. For example, suppose that because of falling house prices a homeowner walks away from a mortgage, leaving behind a low-valued house to be foreclosed at a price below the outstanding mortgage (loan principal less insurance cash value) the accumulated insurance surplus of the insurance-funded mortgage product type is utilized to support the company if insurance-funded mortgage asset is on the balance sheet or to support bondholders if the insurance-funded mortgage asset that was securitized. Furthermore, reinsurance of the life insurance component of insurance-funded mortgage provides additional guarantees to investors of life insurance-backed mortgage obligations securities in the event of policy lapses, adverse mortality experience, and adverse investment experience. Insurance companies transfer their own portfolio risk to other reinsurance companies via reinsurance.

The financial holding company has the option of being self-insured by the insurance reserves and the accumulated surpluses of insurance-funded mortgage products (bearing the risk of default) or insured through FHA/VA housing insurance that bears the risk of default for off-balance sheet life insurance backed mortgage obligations securities. Regardless of the option, bank depositors and capital market investors are fully protected due to the existence of life insurance reserves and accumulated surpluses. Because of life insurance reserve, surplus, and reinsurance, life insurance backed mortgage obligations securities offer much more protection to investors than conventional mortgage securities. Whether self-guaranteed or self-insured by the financial holding company, insurance-funded mortgage-backed security issue is safe enough to acquire the Standard & Poor's Corporation highest AAA rating.

By utilizing life insurance reserve and surplus as additional collateral to back life insurance backed mortgage obligations securities, overcollateralization common to securitization of traditional mortgage securities is eliminated. Typical prior art mortgage securities use overcollateralization and excess spread to provide a default buffer. Insurance-funded mortgage securities, in contrast, use life insurance reserves and surpluses to provide default buffer. Overcollateralization refers to the difference between the principal balance on the loans in the pool and the principal balance on the outstanding MBSs. Excess spread is the difference between the interest payments coming in (loan payments minus servicing fees) and the weighted average payments going to bondholders. They are related in that excess spread is also used to build up overcollateralization. The first use of excess spread is to cover default losses. If any excess spread is left, it can be used to build up a cushion against future losses (e.g., one way to do this is to pay down the principal on senior bonds). The use of life insurance reserves and surpluses as additional guarantees of life-insurance backed mortgage obligations securities eliminates the need to over collateralize to attract more investors thus reducing securitization cost to the financial holding company and increasing financial holding company's optimum profitability.

By eliminating prepayment risk, the reduction of default risk, and the backing of life insurance reserve and accumulated surplus, a virtual limitless securitization process is created, as there is constant demand of mortgage funds by new homeowners and constant supply of mortgage funds by investors. In addition, the financial holding company is enabled to be self-guarantors of their mortgage pools instead of government sponsored enterprises and to be self-insured instead of FHA/VA.

In essence, insurance-funded mortgage securitization transfers mortgage risk and mortality risk of life insurance-backed mortgage to the capital markets. It is conceivable that an indexed structure of insurance-funded mortgages will emerge to make it easier for investors to analyze the risk of life-insurance backed mortgage obligations securities. Moreover, insurance-funded mortgage index means that investors do not need to understand the details of each insurance-funded mortgage business.

Preferably, security types are categorized according to the primary investment objectives of major segments of the investment community. Securities are preferably created that are suitable to the investment objectives of groups of investors such as pension funds, including private and government, mutual funds, hedge funds, trusts, foundations, and individual investors. Life-insurance backed mortgage obligations securities include life insurance-backed securities that have similar investment features of loan sales, swaps, pass-through security, collateralized mortgage obligation, mortgage-backed bond, mortgage pass-through strip, collateralized debt obligations, and structured investment vehicles, which are issue short- and medium-term debt structures, backed by pools of assets, such as MBSs, and collateralized debt obligations, which are longer-term debts. Each type of life insurance backed mortgage obligations security is preferably designed to meet the unique needs of different groups of investors in the capital markets.

For example, the unique characteristics of a pension fund, a mutual fund, or a hedged fund are matched with similar unique characteristics of life insurance-backed mortgages to create investment product types appropriate for groups of investors. For example, a life insurance backed mortgage obligations security type is derived for a pension fund matching the duration of mortgages and the respective insurance pools to the duration of pension funds. Each life insurance backed mortgage obligations security is preferably created for a specific duration and each such investment security is backed by life insurance pool that has mortgage duration similar to the security duration. The insurance pool is preferably designed to accumulate surplus that further protects pension investments in mortgages in times of adverse mortgage experience and mortality experience. Moreover, a life-insurance backed mortgage obligations security type is created that is based on the peculiar characteristics of a group of investors. Each security type derived from insurance-funded mortgage product is designed not only to maximize rate of return on investment given the risk level but also to address the concerns of the investment community such as cash flow, prepayment, and default risks.

Among the benefits of the life-insurance backed mortgage obligations securities according to the teachings herein include an infusion of capital market funds into the new industry to enable prospective homeowners to achieve individual financial objective, maximization of returns of investment for investor community, and optimization of profitability for the financial holding company.

Through securitization of insurance-funded mortgages and backing them with life insurance pool, the financial holding company is able to substitute long-term mortgages for cash quickly and easily, is able to greatly reduce duration mismatch, and is further able to reduce capital requirements, reserve requirements, and deposit insurance premiums if the bank uses securitization proceeds to retire demand deposits. Moreover, investors are able to hedge their interest rate exposure gaps, and the financial holding company is enabled to liquidate its mortgage asset portfolio, while the effects of regulation are reduced. Moreover, the risk-return trade-off for the financial holding company is reduced. Since investors can invest in life insurance backed mortgage obligations securities directly or indirectly (e.g., through mutual funds), these enhanced asset-backed securities allow a broad investor base to help fund insurance-funded mortgages. Thus, securitization of insurance-funded mortgages into life-insurance backed mortgage obligations securities enables the financial holding company to optimize profitability, especially given the constraints of duration, liquidity, and regulation requirements associated with typical, prior art mortgages.

Since banks finance insurance-funded mortgage out of short-term deposits such as certificate of deposits or other time deposits, life-insurance backed mortgage obligations securities enables the baking division of financial holding company to eliminate gap exposures due to duration mismatch and since mortgages are very illiquid long-term assets, life-insurance backed mortgage obligations enables the financial holding company to eliminate potential liquidity shortages that can potentially trigger mortgage asset fire sales to meet large unexpected deposit withdrawals. The financial holding company packages insurance-funded mortgage loans and removes them from the balance sheet by placing them with a third-party trustee off the balance sheet.

By controlling default and prepayment risks, insurance-funded mortgage securitization reduces mortgage yield spreads and volatility. For example, the yield spread between a 10-year life-insurance backed mortgage obligations security and 10-year constant maturity treasury rates is estimated to decrease by approximately 8.0 basis points per $1 billion of insurance-funded mortgage securitization. Thus, insurance-funded mortgage securitization influences interest spread much more downward compared to the spread of traditional mortgage loan rates. Interest spread, as known in the art, is the difference between mortgage interest rate and coupon rate of the security derived therefrom. Additionally, insurance-funded mortgage securitization significantly reduces mortgage yield volatility. The activities of life insurance backed mortgage obligations securities will reduce and stabilize life insurance-backed mortgage market rates than the activities of traditional mortgage securities.

Unlike traditional mortgage securitization, insurance-funded mortgage securitization does not encourage lax lending in the mortgage industry. Because of the integrated life insurance component that backs mortgages, the bundling of mortgage loans into assets that could be sold to investors do not break the link between those who vet borrowers (the mortgage banking unit of the financial holding company) and those who bear the cost when there is default (the life insurance unit of the financial holding company). The life insurance affiliate or partner is compelled to ensure the creditworthiness of prospective homeowners. Poor screening by originators intent on selling loans based on traditional mortgages, which was a significant factor in the housing bust of 2005 to 2008, cannot similarly afflict harm as a function of insurance-funded mortgage securitization. Where the interests of mortgage originators and insurers are aligned, subsequent defaults are far less likely. Since life insurers are backing insurance-funded mortgage securities with reserves and surpluses on their books, lax lending cannot be a strategy of the mortgage banking affiliate or partner. Insurance-funded mortgage securitization does not encourage sub substandard lending and, therefore, borrowers are far less likely to default on their mortgages. Therefore, adverse selection in the traditional mortgage industry and “moral hazard,” the tendency amongst traditional mortgage originators to neglect caution, prudence, and due diligence in the origination of mortgage, are eliminated in the insurance-funded mortgage industry.

Insurance-funded mortgage securitization offers improvement in access to mortgage financing. It will make the mortgage market more competitive and transparent due to the need to inform the capital markets about the underlying life insurance reserves and surpluses. This plays a critical role in building market confidence in the mortgage industry and in stimulating more growth in the capital markets.

Life insurance-backed securities offer high spreads and returns compared to corresponding treasuries of similar duration and are uncorrelated with other financial assets, which makes it much more attractive to all groups of investors. Mortality risk is essentially uncorrelated with market risk. This coupled with their high expected excess returns make life insurance backed mortgage obligations securities major assets. Life insurance backed mortgage obligations securities offer investors both a high potential for growth and a non-correlation with the stock market. Life insurance backed mortgage obligations securities are high yield, low risk hedge, thus making them a much more viable than traditional prior art mortgage securities. Due to the high attraction of the capital markets, insurance-funded mortgage securitization an extremely lucrative market in the financial services industry. Investors are able to appropriately diversify portfolios.

Accordingly, a comprehensive integration of concepts, products, strategies, processes, procedures, and organizations, technology and finances is provided in accordance with the teachings herein. A dependable way of collective financing of personal financial goals and achieving maximum protection for all stakeholders is further provided. This is accomplished via mortgage and insurance concepts united to create a new financial services industry. Economic or financial concepts underpinning mortgage and wealth accumulation are united with social or collective concepts underpinning insurances—life, health, and unemployment. Moreover, disability, critical illness, and unemployment waivers associated with a mortgage and insurance contract provides solid protection for all. To continuously strengthen financial protections, the personal financial planning strategies described herein (e.g., HOPS) and the various security types (i.e., life-insurance backed mortgage obligations), bring more people and more capital into the insurance pool. Through comprehensive integration, stakeholders of the new financial industry are enabled to achieve their respective financial goals.

Preferably, mortgagees (i.e., borrowers) are able to obtain a mortgage and to pay only interest on the loan. The principal of the mortgage is preferably paid by revenue originating from an external source, such as a life insurance policy, that is maintained by the borrower and which directs the lender to be the beneficiary. Thus, unlike typical prior art mortgage payments that combine interest and principal payments, payments of the principal amount of a mortgage are paid from proceeds of a life insurance policy, following an event that triggers payment of proceeds, such as the death of the policy holder or another event which terminates the mortgage, e.g., its maturity. The mortgagee is responsible for interest-only payments on the mortgage, and is further responsible for maintaining an insurance policy that guarantees payment of the principal amount. The mortgagor is preferably the same party as the insurer, and is further the owner and the beneficiary of the policy. In this way, the mortgagor is able to exercise control in the event that the borrower (i.e., mortgagee) defaults on the loan.

A typical prior art life insurance policy names at least one person to receive the life insurance proceeds (i.e., a beneficiary) upon some event that triggers proceed payments, such as the death of the insured. Payments to the insurance company, for example, by the insured (i.e., premiums) ensures the life insurance policy is in force until some terminating event, such as voluntary termination, lack of premium payments, or death of the insured. Various forms of life insurance are available, such as term life insurance, which does not build up cash value and where the premium normally increases as the insured gets older. Whole life insurance (or “permanent” insurance), in contrast, typically builds up a cash value and has a fixed level of premiums. Both term life insurance and whole life insurance, generally, require premiums to be paid as long as the policy remains in force. Either term life insurance, whole life insurance, or some combination thereof can be used in accordance with the teachings herein. Furthermore, term insurance may be converted to whole life insurance during the life of the insured.

Compared to conventional mortgages, where payment towards principal is included in monthly payments, interest-only payment reduces monthly payments. In accordance with an embodiment, in order to reduce monthly payments even further (than interest-only), a negative amortization mortgage may be used, as known to those skilled in the art. In accordance with this embodiment, the amount by which each monthly payment is reduced is preferably added to the principal amount borrowed for the total balance that has to be paid off. In accordance with the teachings herein, the remaining (total) balance is paid from life insurance proceeds, thereby resulting in an increase in the amount of life insurance purchased by the borrower.

In yet another embodiment, in order to exercise the control that a mortgagor has over a policy, in the States where the law does not permit for a lender to own the life insurance policy on the borrower's life, a trust is preferably established that defines mortgagor as the beneficiary. In accordance with this embodiment, the mortgagor realizes the benefits of the trust in case of a default in payment in the life insurance premiums, the interest payments on the mortgage, or both. To the extent that a principal of the trust has accrued, the body of the trust is preferably the cash value of the life insurance policy. Also in accordance with this embodiment, the mortgagee does not own the cash value of the insurance policy. Instead, the cash value is protected in the trust, and falls under the control of the lender in case of default on payments of premium

Moreover, the life insurance policy may support a disability, critical illness, or unemployment waiver that can be extended to cover interest payments on the mortgage. For example, the mortgagee may pay an additional amount for the life insurance policy to cover payments the mortgagee is unable to make in case of becoming disabled. Thus, a disability, critical illness, or unemployment rider clause can be included, optionally at an additional cost, to rider which provides payments to cover one or both of the interest payments on the mortgage and the premium payments on the life insurance policy during a period of disability, critical illness, or unemployment. Accordingly, a virtual full financial protection system is provided in accordance with the teachings herein.

In an alternative embodiment, a life insurance policy may be purchased on the life of a borrower's parent or close relative, who has a shorter life expectancy than the borrower. In this embodiment, the likelihood is that the triggering event resulting in payment proceeds on the insurance policy will occur much sooner than if the policy was taken for the borrower (i.e., mortgagee). The benefit of this embodiment is that the principal of the mortgage will likely be paid sooner rather than later. In other words, the life insurance policy is taken for a person who is likely to die sooner than the borrower. The burden of this embodiment is that the monthly premiums are likely to be higher than if the life insurance policy is on the borrower. Typically, and particularly with respect to term insurance, the amount of premium payments increase as the likelihood of the insured party's death becomes more imminent. Thus, premium payments on a life insurance policy on a twenty-five year old are much lower than premium payments on a sixty-five year old.

As noted above, a whole life insurance policy has a guaranteed cash value accumulation. Further, a whole life insurance policy has an annual dividend which, typically, is not guaranteed. In case whole (or permanent) life insurance is purchased, or a combination of whole and term is purchased, then in accordance with the teachings herein, three formulas for calculating monthly payments are envisioned herein. Each of the formulas relates to an annual calculation, which is divided by twelve (for the number of months in the year). First, the dividends option may be used to reduce the premium and calculated as: (mortgage amount-guaranteed cash value)*interest rate+annual insurance premium-annual dividends=required payment. Second, the dividends option may be used to increase the policy's cash value and calculated as: (mortgage amount-policy cash value)*interest rate+annual insurance premium=required payment. Third, monthly payments (preferably defined as (((mortgage amount*interest rate)+annual insurance premium amount)/12) may remain unchanged, and the difference between the monthly payments and a required monthly payment (preferably calculated as ((mortgage amount−policy cash value)*interest rate)+annual insurance premium)/12) is used to increase a policy's cash value (known in the art as an “enricher rider”). In this case, the dividend option may be used to increase a policy's cash value until annual dividends are equal or higher than a required monthly payment amount and can be used to make required payments. The formula to calculate enricher rider amount is: ((mortgage amount*interest rate)+annual insurance premium amount)/12)−required monthly payment=enricher rider amount.

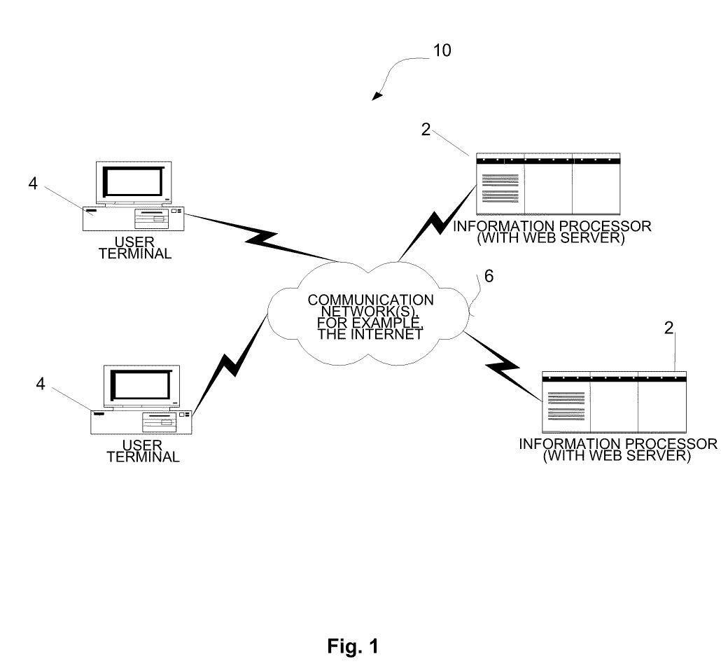

Referring to the drawings, in which like reference numerals refer to like elements, FIG. 1 shows an example hardware arrangement in a preferred embodiment and referred to generally as system 10. In the embodiment shown in FIG. 1, system 10 comprises at least one information processor 2 (configured to operate as an internet web server) adapted to access communication network 6 and communicate with user terminals 4. Preferably, user terminals 4 and information processor(s) 2 communicate via the known communications protocol, Transmission Control Protocol/Internet Protocol “TCP/IP.” In this way, content can be transmitted to and from the devices 2 and 4, and commands can be executed to enable the various functions described herein.

As used herein, the term, “module” refers, generally, to one or more discrete components that contribute to the effectiveness of the teachings herein. Modules can operate or, alternatively, depend upon one or more other modules in order to function.

Information processors 2 and user terminals 4 are any devices that are capable of sending and receiving data across communication network 6, e.g., mainframe computers, mini computers, personal computers, laptop computers, a personal digital assistants (PDA) and internet access devices such as Web TV. In addition, information processors 2 and user terminals 4 are preferably equipped with a web browser, such as MICROSOFT INTERNET EXPLORER, NETSCAPE NAVIGATOR, MOZILLA FIRREFOX or the like. Thus, as envisioned herein, information processor 2 and/or user terminals 4 are devices that can communicate over a network and can be operated anywhere, including, for example, moving vehicles.

One skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, and a plurality web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user terminals 4 and information processor 2, for example, DOS, WINDOWS 3..times, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, various suitable multi-media file types are preferably supported, including (but not limited to) JPEG, BMP, GIF, TIFF, MPEG, AVI, SWF, RAW or the like (as known to those skilled in the art).

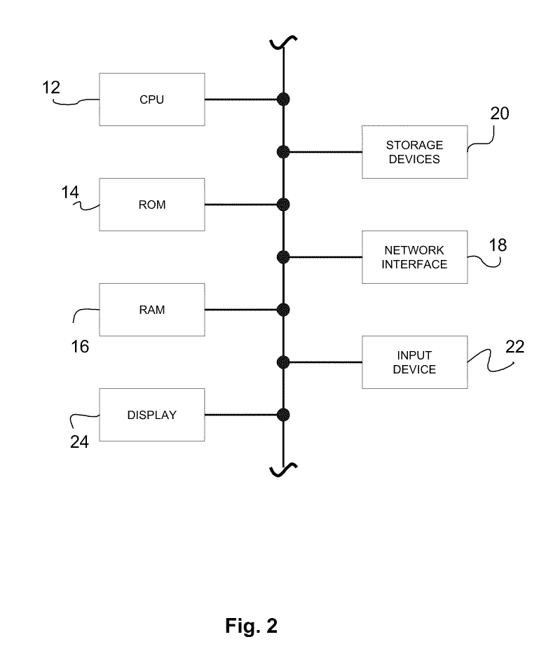

FIG. 2 illustrates the functional elements of user terminal 4 and/or information processor 2 and that include one or more central processing units (CPU) 12 used to execute software code and control the operation of user terminal 4, read-only memory (ROM) 14, random access memory (RAM) 16, one or more network interfaces 18 to transmit and receive data to and from other computing devices across a communication network, storage devices 20 such as a hard disk drive, floppy disk drive, tape drive, CD ROM or DVD for storing program code, databases and application data, one or more input devices 22 such as a keyboard, mouse, track ball, microphone and the like, and a display 24.

The various components of information processor 2 and/or user terminal 4 need not be physically contained within the same chassis or even located in a single location. For example, storage device 20 may be located at a site which is remote from the remaining elements of information processor 2 or user terminal 4, and may even be connected to CPU 12 across communication network 6 via network interface 18. Information processor 2 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user terminals 4. Information processors 2 are arranged with components, for example, those shown in FIG. 2, suitable for the expected operating environment of information processor 2. The CPU(s) 12, network interface(s) 18 and memory and storage devices are selected to ensure that capacities are arranged to accommodate expected demand.

As well understood by those of ordinary skill in the art, FIG. 2 represents a basic computer construct consisting of hardware and software for executing the various steps and for delivering the results described herein. That system, including its hardware and software components, is designed to carry out the various calculations needed to derive the exact payments that are payable both relative to the mortgage and to the life insurance policy or policies. In a financial partnership, a mortgage application and insurance application are integrated to perform these calculations simultaneously, effectively, and efficiently. In a financial holding company, the mortgage and insurance calculations are preferably performed on a single system platform, thereby providing fast, easy, effective, and efficient processing and management of the financial contract.

In one embodiment, methods provided herein are practiced at least in part on a computing device that implements one or more algorithms. For example, methods are implemented for structuring product types, allocating periodic mortgage interest payments and making life insurance premium payments towards repayment of mortgage principal, as well as for optimizing ownership and protection investment according to the financial plan of the homeowner and optimizing interest yields according to the investment objective of the mortgage investor. Optimizations are performed at least partially by a programmed computing device. For example, periodic automatic calculations of required payments are made to satisfy periodic payments of mortgage interest and life insurance premium. Interest and premium payments are preferably allocated that are compliant with the contract agreement. Accordingly, a system and method is provided for organizing a financial product to provide for an allocation of payments into mortgage and insurance amounts, and ownership and protection investments as well.

Preferably, algorithms are provided for modeling one or more expected investment results over a predetermined investment period that are based on parameters preferably chosen by the homeowner. Algorithms are also provided for managing the separate account investments of the homeowner. Investment outcomes, for example, can be electronically displayed, stored on a database, and accessed for future use. Accordingly, information that is be stored on a computing device having, for example, elements such as shown in FIG. 2 Accordingly, fund and homeowner information is preferably stored in a memory in a computing device or, alternatively, in a removable data medium such as a magnetic disk, a CDROM, a tape, or an optical disk. In a preferred embodiment, information is distributed in a networked environment, including a plurality of networked computers.

In an embodiment, information regarding a mortgage, the insurance policy and the underlying funding mechanisms, including general investment models such as the guaranteed returns option and investor-specific models as such the variable returns option can be accessed and/or transmitted across the network. For example, information is accessed and/transmitted on a web-based system using a web browser running on a workstation. According to preferred embodiments, methods for selecting product types and allocating payments, and/or accumulating individual and policy reserve funds are implemented on a computer system, such as a computer system described above. Such a computer system may be a portable computer.

One of the software modules may include a tax benefits calculator designed to derive or calculate the highest payment permissible on the insurance policy which will maximize the favorable tax treatment under the then-current tax laws of the United States. For example, the software will calculate for a particular mortgage balance and insured the amounts required to be paid to permit sufficient monthly contributions or payments on the life insurance policy that will allow building up the desired cash amounts at the conclusion of a predefined or selectable time period.

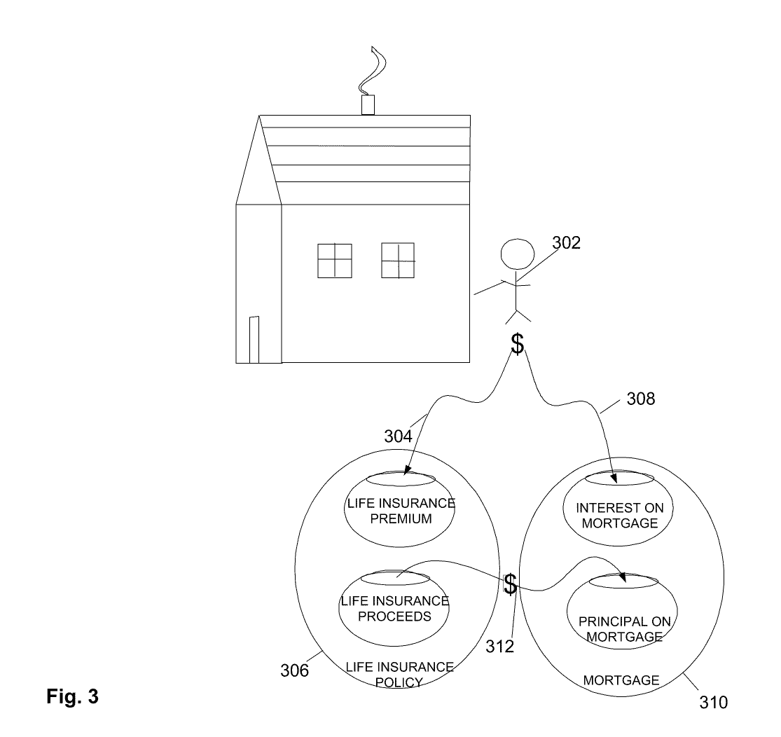

FIG. 3 illustrates an embodiment. As shown in FIG. 3, borrower 302 remits two kinds of financial payments: one payment 304 for paying a premium on life insurance policy 306, and one payment 308 for paying the interest on mortgage 310. Although the embodiment in FIG. 3 shows a single person making both payments 304 and 308, the invention is not so limited. It is envisioned herein that a plurality of parties may make payments 304 and 308, without departing from the teachings herein. For example, prior art life insurance policies typically designate beneficiaries who do not contribute financially to the costs associated with the policy (i.e., make premium payments). Furthermore, in the prior art, a third party may pay for a house owned by another party that is named on the property deed. Thus, it is envisioned herein that one or more parties may contribute payments 304 and 308, at least to the extent permitted by law.

Continuing with reference to FIG. 3, payments 312 are preferably made from proceeds of life insurance policy 306 which are applied to the principal of mortgage 310. Unlike prior art arrangements wherein a beneficiary realizes the proceeds of a life insurance policy and, thereafter, can make mortgage-related payments, life insurance policy proceeds are preferably reserved exclusively for the principal of a mortgage. One skilled in the art will recognize that a borrower may make payments that are applied to the principal of a mortgage. Any payments applied to the principal results in a reduction in interest-only payments and further a reduction in the premium of the life insurance policy because the principal amount of the mortgage is reduced. In another embodiment, the premium of the policy is not reduced but the difference between policy face value and the remaining outstanding principal at the time of insured death is paid to the beneficiary of homeowner. Thus, life insurance proceeds are reserved for the repayment of principal although mortgage principal may be reduced periodically.

Preferably, information processor 2 tracks payments that are made by borrower 302 (or other party) that are applied to the premium of the life insurance policy, to the interest only payments on the mortgage, and/or to the principal of the mortgage. By tracking these payments simultaneously through integrated mortgage and insurance system applications or common system application, information processor 2 preferably determines appropriate adjustments to the life insurance policy, the premiums of the life insurance policy and to the interest only payments on the mortgage. Further, information processor 2 preferably operates to guarantee that the life insurance policy is sufficient to cover the outstanding principal on the mortgage.

In accordance with the teachings herein, the mortgagor (i.e., lender) and the insurer may be the same party. For example, a person takes out a life insurance policy with a company, and further takes out a mortgage with the same company. The mortgagor (i.e., the company) may use the proceeds that it pays from the life insurance policy to cover the principal amount of the mortgage. Moreover, businesses that were at one time exclusively involved in either the insurance industry or the lending industry may evolve into some sort of hybrid in order to be availed of the methods and/or systems defined herein. In this way, mortgagors can exercise control in case the borrower defaults on either the monthly insurance premiums, the monthly interest payments or both, by foreclosing on the property. Moreover, lenders are guaranteed payment of the principal amount of a loan by being beneficiaries of life insurance policies.

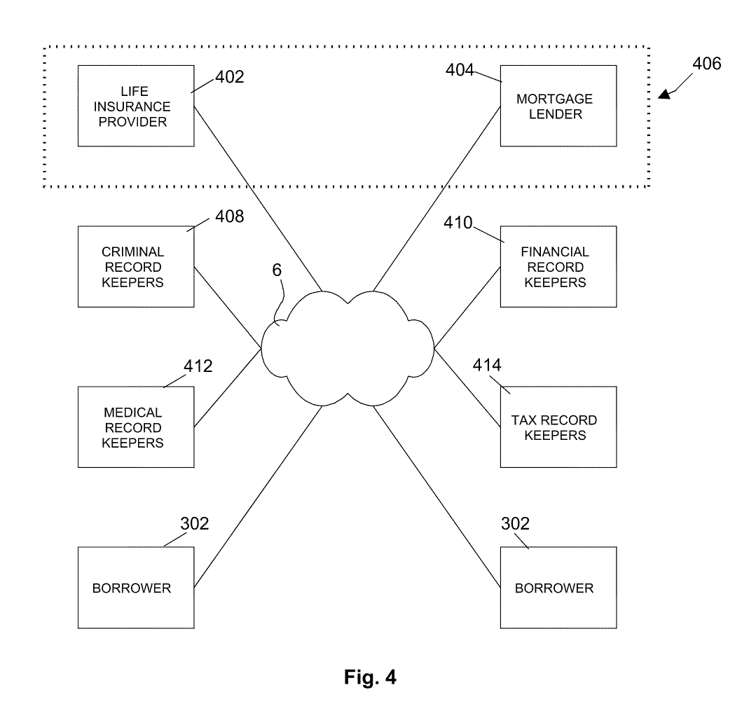

FIG. 4 is a block diagram that illustrates an example networked arrangement of parties, such as over the internet, associated with the teachings herein. Various parties communicate information to each other that is useful or necessary to execute the teachings herein. For example, issuers of life insurance policies and issuers of mortgages require various kinds of information in order to make an informed decision whether to insure someone or grant a mortgage to someone. One skilled in the art will recognize that the internet enables the convenient and rapid exchange of information, thereby enabling parties to decide whether to grant someone a life insurance policy and/or a mortgage.

Continuing with reference to FIG. 4, life insurance provider 402 and mortgage lender 404 are shown surrounded by a dotted line. The dotted line symbolizes that the life insurance provider 402 and mortgage lender 404 may be the same company 406, or, alternatively, different companies. Other information providers represented in FIG. 4 include criminal records keepers 408, financial record keepers 410, medical record keepers 412, generally and tax record keepers 414. The term “keepers” is merely illustrative, and represents that these parties have access to information, and can provide information to provider 402 and lender 404. Further, one skilled in the art will recognize that various other parties are capable of providing information to life insurance provider 402 and/or mortgage lender 404, and are envisioned herein to be included among the parties listed in FIG. 4. In accordance with the teachings herein, a life insurance provider 402 and/or mortgage lender 404 receives information substantially automatically from various parties acting as sources of information regarding an insurance policy and/or mortgage applicant.

For example, a prospective mortgagee who desires to avail himself of the benefits of the teachings herein applies for the financial product according to the teachings herein, including a desire to simultaneously purchase a product including a life insurance policy and a mortgage. The prospective mortgagee logs on to a web site provided by information processor 2 and completes a data entry form to submit an application for the life insurance policy. The applicant intentionally omits important information regarding his health. The life insurance provider 402 (via information processor 2) uses the information received from the applicant to request additional information about the applicant from various parties, such as represented in the block diagram shown in FIG. 4. A medical records holder of the applicant's health records (e.g., medical records keeper 412) transmits information to provider 402 that identifies the applicant's pre-existing condition. Insurance provider 402 uses the information to avoid insuring someone who dishonestly omits information on his application. This example illustrates how information can be transmitted between parties (such as shown in FIG. 4) in order to enable accurate and timely decisions regarding insuring someone and/or granting someone a mortgage. In another example, a mortgagor receives information from a financial record keeper 410 that indicates a prospective mortgagee is a high-risk applicant. Thus, information is able to be provided rapidly, preferably over the internet, from a plurality of parties, thereby enabling key players to make informed decisions. Further, any known technology may be availed for an efficient implementation.

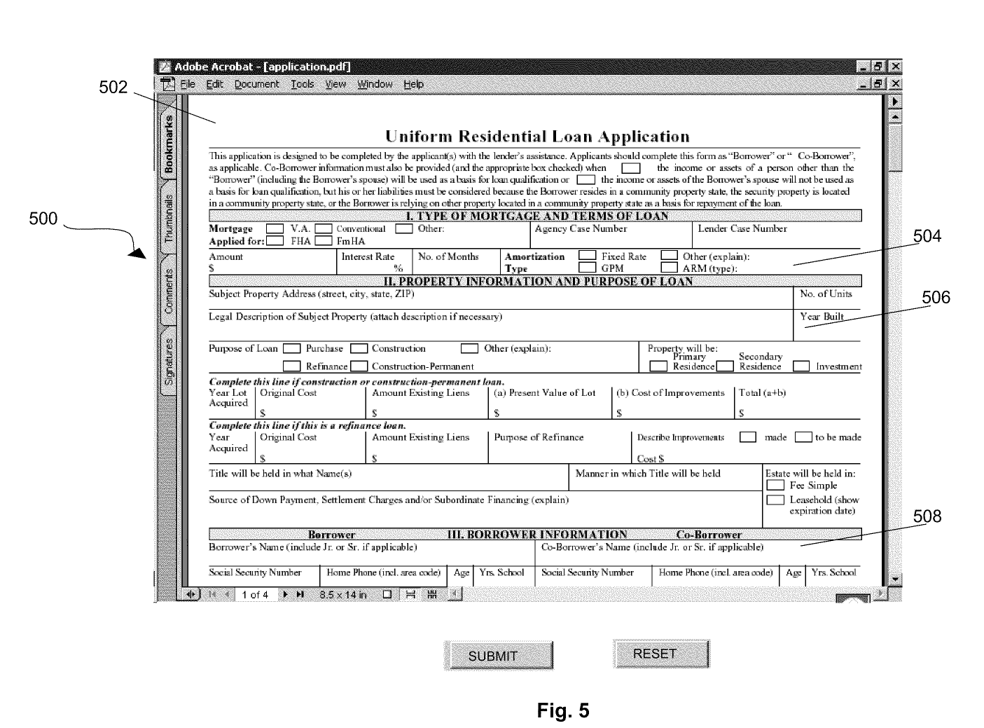

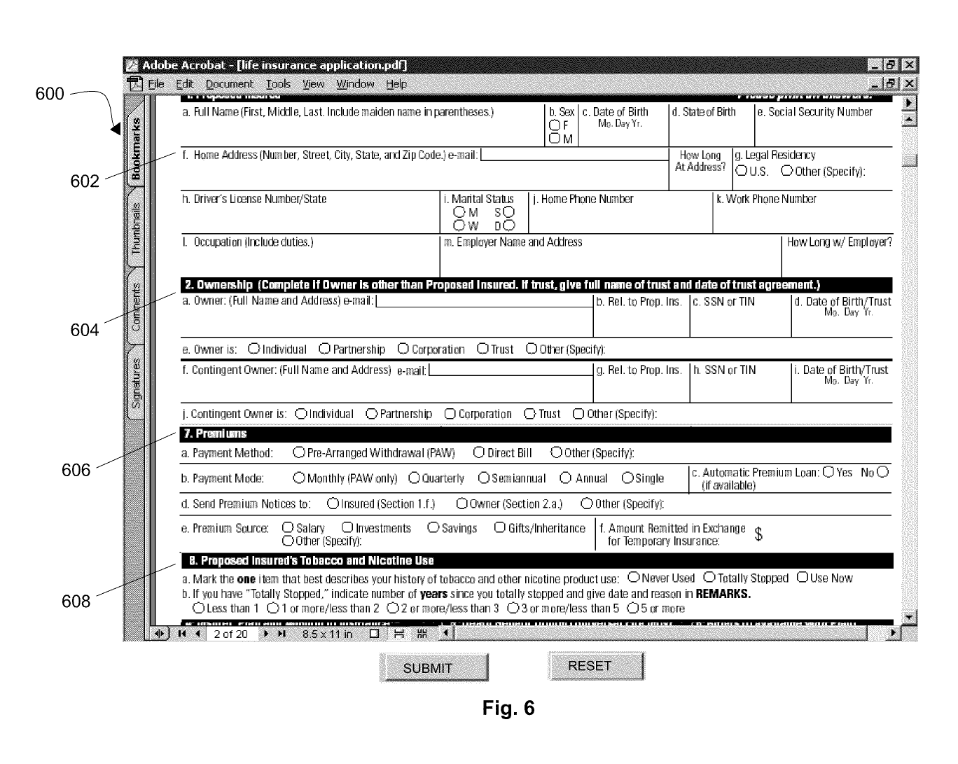

FIGS. 5 and 6 illustrate an embodiment wherein prospective borrowers use the internet and the “World Wide Web” to apply for mortgages and/or life insurance policies. Preferably, secure internet web sites are provided that enable prospective borrowers to submit information to an information processor in order to avail themselves of the features described herein. For example, information processor 2 functioning in part as an internet web server provides a prospective borrower or other user with secured access (e.g., via the secured sockets layer protocol (“SSL”), encryption, and/or other security-related techniques) to one or more web sites served by information processor 2. The user preferably registers with information processor 2 by submitting information and thereafter provides a user name and password to gain secured access to web sites provided by information processor 2.

FIG. 5 illustrates a portion of an example of an insurance-funded mortgage application display screen consisting of mortgage and insurance segments. The mortgage application display potion, the first part of screen, 500 preferably includes a data entry form 502 that is provided on the internet and accessible to a user via a standard web browsing software to apply for a mortgage. Data entry form 502 includes graphical screen controls, such as text boxes, check boxes, radio buttons, buttons or the like that enable a mortgage applicant to submit information in an application which is used by a mortgagor to grant or deny a mortgage. With particular reference to the example shown in FIG. 5, mortgage type section 504 includes graphical screen controls that enable an applicant submit information regarding the type of mortgage the applicant desires (e.g., V.A. Federal Housing Authority, Conventional, or the like), the amount of the mortgage, the preferred interest rate, the number of months to pay back the mortgage, the interest type for the mortgage (e.g., fixed or variable), or the like.

Continuing with reference to FIG. 5, the data entry form 502 includes property information section 506 that includes controls enabling a user to submit information regarding the property and/or purpose of the mortgage. For example, the applicant submits information regarding the physical information about the property (e.g., address, and legal description), whether the loan is for a purchase, refinance, construction, or the like, whether the property will be a primary residence, secondary residence, investment or the like, and the name of the party holding the title, source of down payment or the like. In borrower section 508 of data entry form 502, the prospective borrower (and co-borrower, if applicable) submits personal information (e.g., name, address, telephone number, social security number, etc.). Data entry from 502 preferably includes various other sections (not shown) that an applicant uses to submit information regarding the mortgage. For example, sections directed to the borrower's 302 present and past employment, the borrower's 302 assets and liabilities, acknowledgements, etc., as typically provided in mortgage applications, are preferably provided and used by the applicant to submit additional information required by the mortgagor to evaluate the loan and the applicant in order to determine whether to grant the mortgage.

FIG. 6 illustrates a portion of an example life insurance policy application display screen, the second segment of the integrated application screen 600 that includes data entry form 602 for submitting an application for a life insurance policy in accordance with a preferred embodiment. Data entry form 602 includes demographics section 604 and personal information, (e.g., name, address, gender, date of birth, social security number, driver's license number etc.), which are simultaneously populated from the mortgage segment. Ownership section 606 is used to identify whether the owner of the policy is different from the proposed insured party. Premiums section 608 includes data entry controls to be used by the applicant to submit information directing how premium payments are to be made, the frequency of premium payments or the like. Tobacco and nicotine section 610 is preferably provided for the applicant to inform the insurer of present and past tobacco use.

Data entry from 602 preferably includes various other sections (not shown) that an applicant uses to submit information regarding the insurance policy. For example, sections directed to the applicant's medical history, existing insurance policies, authorization to collect and disclose information, and the like are preferably provided to the applicant.

After the applicant has completed the product application, he preferably submits the application, for example, by selecting a button or other control. The contents of the application are preferably simultaneously transmitted to the mortgage lender and to the insurance provider of the financial partnership or transmitted to the mortgage division and insurance division of the financial holding company 402 (or authorized agent thereof). The mortgagor preferably verifies the applicant's submitted information using known processes, such as by communicating with various parties, such as depicted in FIG. 4, including a credit rating company, a bank or the like. The insurance provider 402 preferably verifies the applicant's submitted information using known processes, such as by communicating with various parties, such as depicted in FIG. 4, including a credit rating company, a bank or the like.

Once the mortgage application and/or the insurance policy are approved, then, in accordance with a preferred embodiment, interest payments on the mortgage and premium payments on the life insurance policy are paid by borrower 302 (or other party), and the principal of the mortgage is to be paid by the proceeds from the insurance policy. The proceeds are preferably paid after some triggering event, such as death of the insured. Moreover and as described above, payments can also be applied to the principal of a mortgage (for example, by the borrower), thereby lowering interest payments and also lowering the terms of the life insurance policy and, accordingly, lowering the premium on the life insurance policy. Notwithstanding a life insurance policy fluctuating in response to payments applied to the principal of a mortgage, the proceeds of the insurance policy will be sufficient to cover the principal balance on the mortgage.

Other are envisioned herein. Preferably, a minimum amount of capital, for example, six months worth of insurance premium payments, is held, for example in an escrow account, in order to guarantee that an insurance policy will not lapse for lack of payment of premiums. In this way, a policyholder may default on paying premiums for a certain amount of time, and the lender is protected because the insurance policy will remain in force.

Also, although the examples provided herein regard a single life insurance policy, of which the proceeds are applied to the principal of a single mortgage, the invention is not so limited. For example, it is envisioned that proceeds from a single life insurance policy may be applied to a plurality of mortgages.

Also, although many of the examples described herein are largely made in terms of a mortgage for a residential house, the invention is not so limited. It is envisioned herein that the teachings herein are applicable for commercial real estate, as well as residential real estate. Further, as noted above, mortgages may be granted for various reasons, including for a primary residence, a secondary residence, an investment transaction or the like. Furthermore, although many of the examples herein regard life insurance as a source of revenue to be applied to the principal of a mortgage, the invention is not so limited. It is envisioned herein that the proceeds from virtually any form of insurance can be used to cover costs associated with the principal of a mortgage. For example, proceeds related to health insurance, property insurance or the like can be reserved exclusively to be applied to paying the principal on a mortgage.

The system and software construct described above may be specifically designed o build cash value within a whole life insurance policy, approximately equal to the principal owed on a mortgage in a set time period, for example, thirty years. Alternatively, the insurance policy can be set up to build up sufficient cash to cover the total monthly payments on interest after a set number of years; for example, thirty years.

The software system may additionally include a software module designed to constantly evaluate the rate of return in the whole life insurance policy and to increase or decrease the payments on the insurance policy to achieve the foregoing results. Such a program may include analysis software that takes into account the borrower's age and life expectancy and terminate upon the borrower's death.

The systems and methods provided herein may allow the life insurance component thereof to either close when the underlying property, i.e., the house, is sold, or to be transferred to a new property. In other words, the mortgage amount and the intertwined insurance policy may be transferred from property to property. Ends can be reached by providing a single type of insurance or, perhaps, permanent insurance, such as whole life, UL or VUL, term insurance or combinations of such insurance products. An additional feature is to incorporate in the system a borrowing facility, which enables a borrower to borrow against the cash value of the insurance policy, subject to underwriting. This can extend the thirty-year guarantee to cover monthly payments.

In accordance with another optional feature and to enhance the policy so as to increase cash and dividend accumulation, a portion of the interest payments received from the borrower on the mortgage may be invested in the insurance policy (for example, 0.125% or 0.25%). Additionally, in the situation where there is a down payment on the purchase of the home, entire down payment or a portion thereof may be designated for being invested in an insurance policy. For example, 1% of the mortgage.

Insurance-Funded Mortgage is an integrated one financial product that settles mortgage liability with life insurance proceeds. It is a financial product that brings together aspects of mortgage and life insurance to provide maximum benefit. As noted herein, a life insurance pool is preferably provided to maximum benefits with maximum protection to all stakeholders, including a homeowner, investor, mortgage company and life insurance company. The principal of a mortgage is preferably paid off by life insurance proceeds so that homeownership is affordable and protected. Further, a useful way for borrowing and lending capital is provided that is beneficial to both lenders and borrowers by one financial product that is beneficial to stakeholders in the mortgage industry and in the life insurance industry. Further, the mortgage company benefits from an insurance fund and the insurance company benefits from mortgage sales. Thus and in accordance with the teachings herein, life insurance provides a solution for financial anxieties of stakeholders. Life insurance neutralizes major life threatening contingencies, including employment severance, physical disability, and death.

Accordingly, insurance-funded mortgage products, in accordance with the teachings herein, protect the stakeholders. Investors are provided with a substantial revenue and protection of capital, while homeowners receive affordable home ownership and protection. These benefits are derived, at least in part, from lower interest rates and the existence of insurance pool of mortgagees. Strategically, insurance-funded mortgage products bring homeowners together in an insurance pool, in order to utilize the power of their collective mortality statistics and reduce interest rates and protect their homes. Further, investors utilize the power of the life insurance pool to protect investment principal and to increase investment income. Moreover, banks utilize the power of the insurance pool to protect investments in mortgage assets. Insurance companies utilize mortgage funds as additional source of funds to increase capital and surplus in order to increase protection against adverse experience-mortality, operational, or investment experience.

Moreover, investment outlay in homeownership is lower with insurance-funded mortgage products than with traditional mortgage due to lower mortgage interest rates and an interest build-up of the mortgage repayment cash fund. Insurance-funded mortgage products provide lower tax-deductible amounts than traditional mortgages, at least partly due to a lower cash outlay. This is primarily due to lower mortgage interest rates and the offset of periodic interest credit of a mortgage repayment cash fund. As known in the art, lower tax deductibility is indicative of lower expense. Furthermore, insurance-funded mortgage products build home equity faster than do traditional mortgages, especially in the first ten years of the mortgage term. Insurance-funded mortgage home equity includes the interest build-up of a mortgage repayment cash fund. Accordingly, the incidence of refinance of insurance-funded mortgages are drastically reduced, if not totally eliminated, at least in part because of the stability of lower insurance-funded mortgage interest rates. In the event of refinance, the outstanding mortgage principal to be refinanced is lower with insurance-funded mortgages than with traditional mortgages. This is due to the interest build-up in the insurance-funded mortgage repayment cash fund. Therefore, the equity that can be withdrawn in a refinance is greater with insurance-funded mortgage than with a traditional mortgage, although the amount available for refinance is equal. The amount available is the home value, which equals the outstanding principal plus equity. Pooling of mortgagees, in accordance with the teachings herein, increases the power of mortality savings and the power of interest compounding thus providing substantial insurance-funded mortgage terminal reserve for the protection of stakeholders. In addition to maximizing protection of stakeholders, insurance-funded mortgage products reduce homeowner cash outlay, as compared to traditional mortgage, builds home equity faster, and decreases mortgage loan payoff amount faster.

For example, an average 10-year home ownership rate of the target market (20-49 years old) is 53%, which is far less than the national average of 74%. This low home ownership rate resulted in an average 10-year lost mortgage volume of 1.1 million and lost mortgage revenues of $7.7 billion. The low ownership rate is due to the high interest rate of the traditional mortgage pricing. A potential average annual loss for the next 10 years is 730,000 volume and $15 billion revenue. Because mortgage principal is not insured, mortgage interest rates are high, which reduces volume and revenue.

Insurance-funded mortgage products preferably include optimum pricing that substantially increase a rate of home ownership through the affordability of ownership and protection due to the comparatively lower interest rates made possible by the existence of insurance protection of mortgage principal.

Moreover, insurance-funded mortgage products expand homeownership at substantial profits for businesses because prospective homeowners, who would otherwise be unable to afford homeownership and home protection, can afford both ownership and protection in accordance with the teachings herein. In addition, a financial holding company generates substantial revenues from owner-occupied commercial real estate, which are about 48% of banks' aggregate balance of commercial (non-multifamily) real estate loans. Further, an optimum interest rate of 6% is above 2001 CSO life insurance interest rate of 5%. The 100 basis point spread (“bps”) conforms to historical average interest spread between mortgage interest rates and life insurance interest rates. The spread and the addition of insured new homeowners (about 22% of target market—20 to 49 years old) who otherwise will not own a home and current homeowners (about 20%) who otherwise will not have insurance protection enables the financial holding company to gain additional substantial revenues.

Whether the financial holding company is a mortgage lender (lending bank deposits and/or insurance premiums) or just engaging in mortgage banking as a producer or servicer, the insurance-funded mortgage products generate substantial additional revenues. Lending brings in additional 10% Net Income (33% vs. 23%).

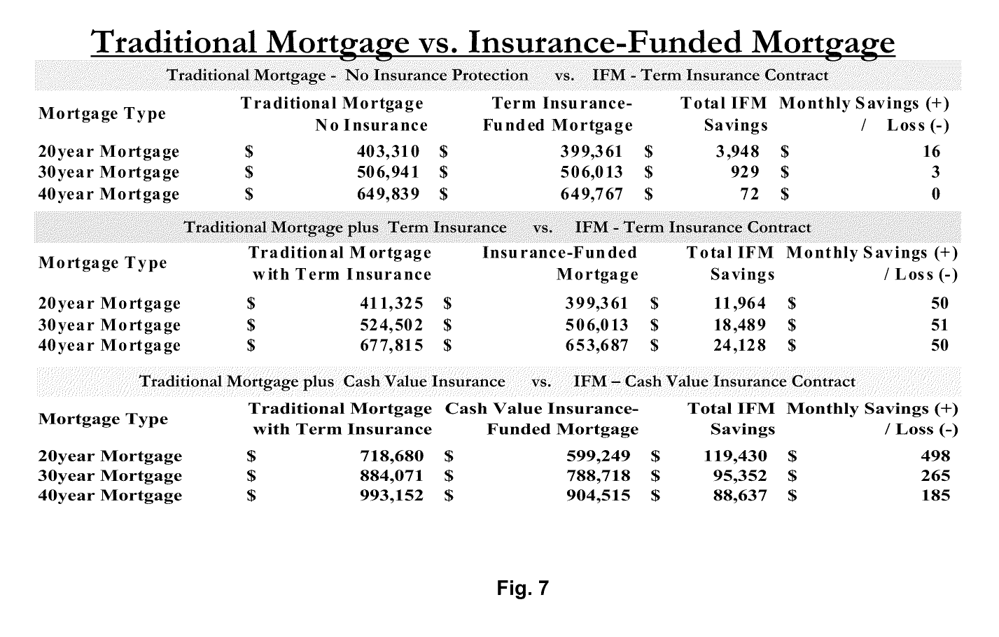

FIG. 7 is a table showing an analysis of the integrated mortgage-insurance product in accordance with an embodiment. In the example shown in FIG. 7, a mortgage loan amount of $195,945, which is estimated to be the average for 2009 yields homeowner ownership and protection savings for a 30 year old, non-smoking homeowner. In the example shown in FIG. 7, the homeowner savings from insurance-funded mortgage product emanate from expense reduction of monthly mortgage and premium payments. The huge savings shown in the 20-year mortgage and the lower cost of protection for 20 to 30 year old age group indicate that insurance-funded mortgage product is ideal for this age group, the group with the lowest percentage of homeownership. The lower the age and duration, the greater the benefits. Further, the cash value insurance-funded mortgage product yields greater benefits for the homeowner because of huge reduction in monthly mortgage payments, lower cost of protection, and the potential of early mortgage pay-off from increasing cash values from moderate or high interest and dividend credits to the account.

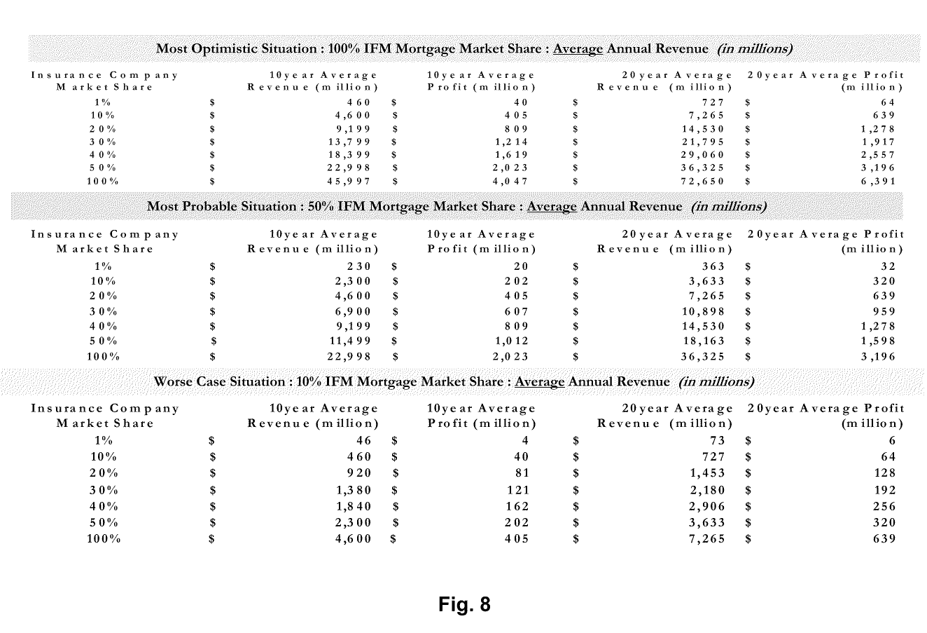

FIG. 8 is a table that shows a summary of average revenue and profit for an insurance company in an example market situation in accordance with an embodiment. In the example shown in FIG. 8, individual life insurance has been increasing by 4% per year while mortgage loan amount has been increasing by 8%. Insurance-funded mortgage income, as a percentage of total individual insurance income of the life insurance industry, is more likely to constitute a greater percentage of insurance company income in the long run. Insurance-funded mortgage income does not include income from homeowners in the age group above 50 years old, which is more than 15% of the mortgage market. At a slightly additional risk to the insurance company, substantial additional insurance-funded mortgage profit can be generated from this age group because of the market size and higher income of the group. Accordingly, the income potential of the insurance-funded mortgage product to the insurance company is substantial.

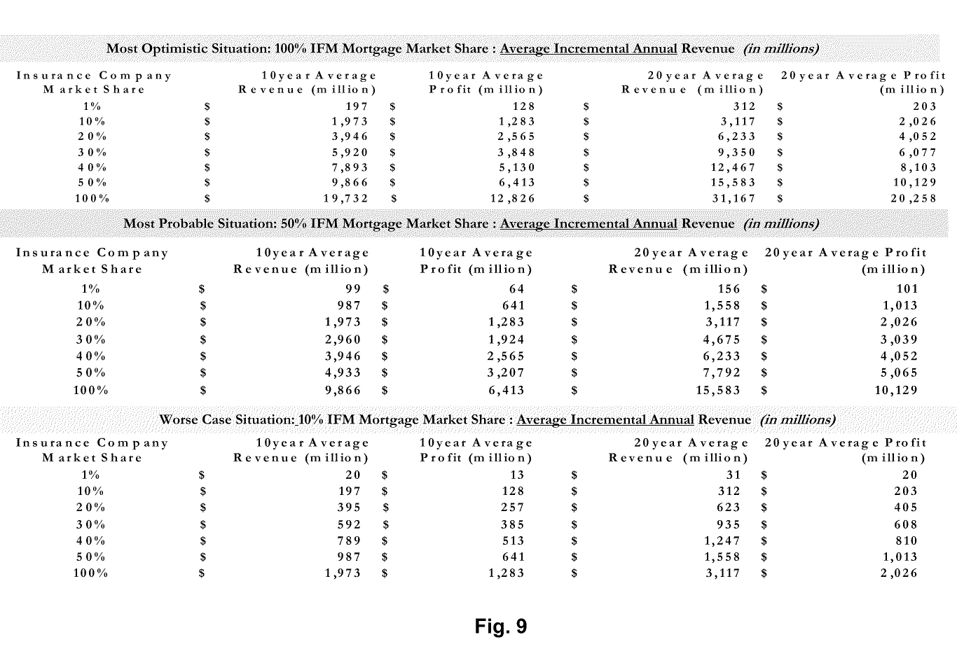

FIG. 9 is a table that shows a summary average incremental revenue and profit for the mortgage company in accordance with an example market situation in accordance with an embodiment. The table indicates that stakeholders of the mortgage industry, e.g., the investors/lenders, the government-sponsored enterprises, and the mortgage company gain substantial after-tax profits. The substantial average incremental revenue shown in FIG. 9 does not include interest revenue to investors. The incremental revenue indicates substantial contribution to the financial strength of the mortgage company. The insurance-funded mortgage product increases company production and service revenues without a corresponding substantial increase in company expenses.

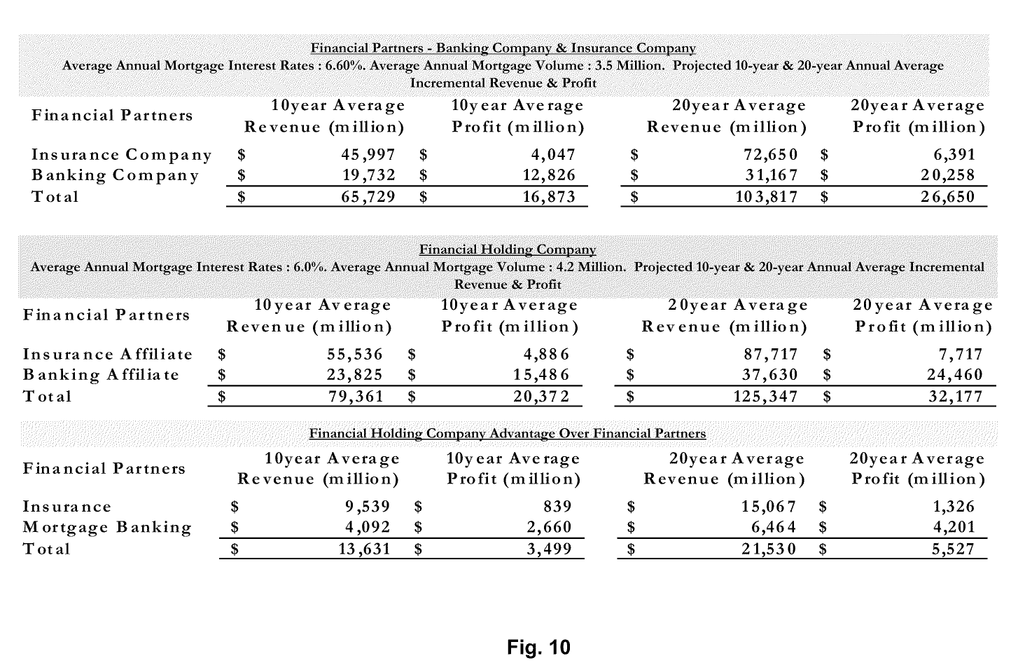

FIG. 10 shows three tables regarding the integrated mortgage-insurance product, and indicates substantial gain to the financial institution holding, a mortgage banking company and a life insurance company. The tables in FIG. 10 show a summary comparison of average revenue and profit for a banking company and insurance company that are financial partners compared to a financial holding company that has a banking and insurance affiliates. Additional gain is derived from the ability to produce at the optimum interest rate and from operation synergy. An inverse relationship of interest rates and mortgage production volume indicates that maximum revenue is generated at the optimum interest rate, which is 6%. Since the probability of mortgage default is significantly reduced by the life insurance policy reserve, the financial holding company has the ability to manage the interest rate to produce at the optimum, that is, at a mortgage volume that produces the greatest revenues. Accordingly, mortgage and life insurance production decisions are made under one senior executive in a holding company coupled with the ability to coordinate implementation of decisions and to leverage access to capital markets, deposit market, and life insurance pool enables optimum mortgage production.

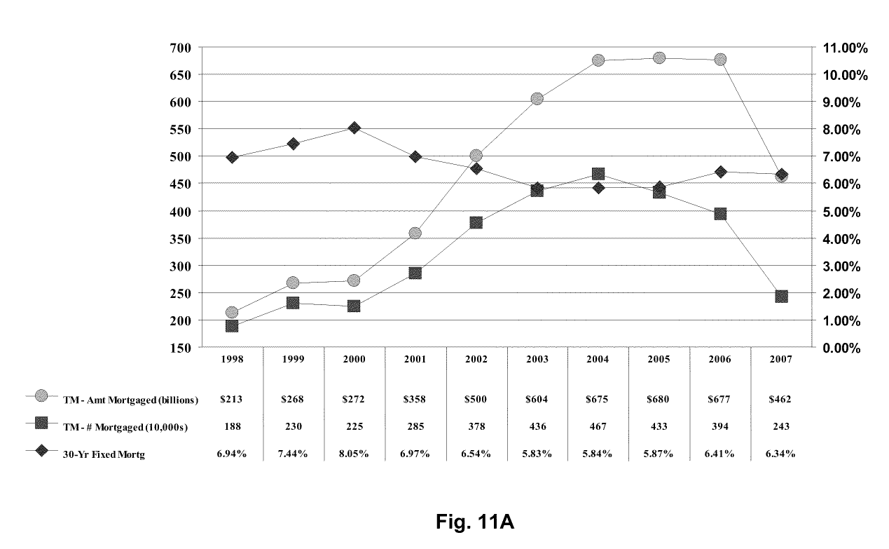

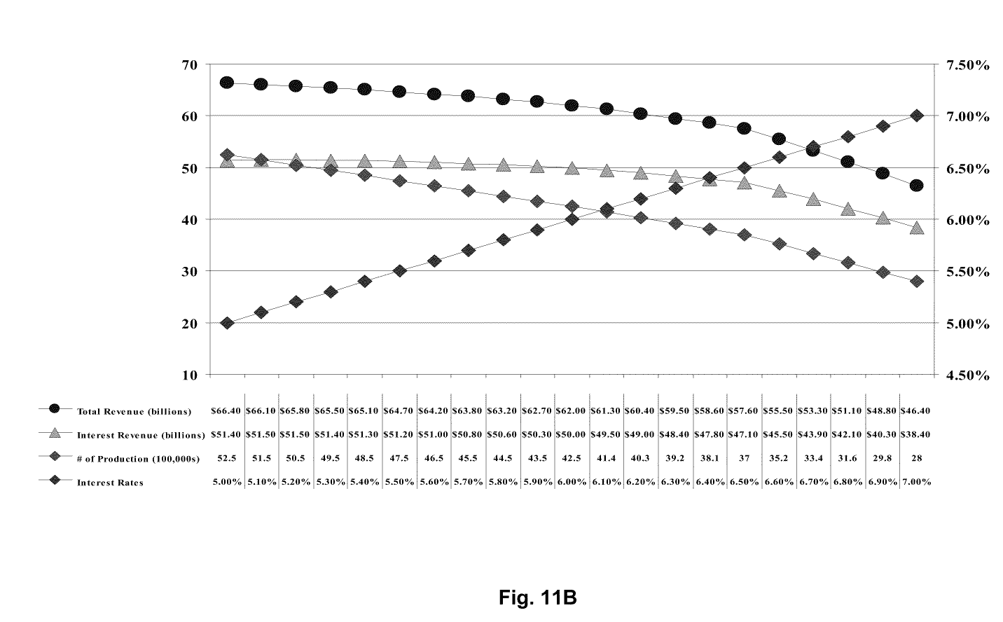

FIG. 11A is a graph illustrating the relationship between mortgage interest rate and home purchases according to the prior art, and shows an inverse relationship of interest rate and revenues using 10 year historical data. The historical analysis that indicates that an interest rate increase triggers a decrease in the number of mortgages and the corresponding amount of revenue. One bps interest rate increases from the optimum, decreases mortgage volume by 11,000, to 18,000. One bps interest rate decrease from the optimum, increases mortgage volume by 10,000. This indicates that prospective homeowners are more sensitive to interest rate increases above the optimum rate. Average 10-year Home Ownership Rate of the Target Market (20-49 years old) is 53%, which is far less than the national average of 74%. This low home ownership rate resulted in an average 10-year lost mortgage volume of 1.1 million and lost mortgage revenues of $7.7 billion. The low ownership rate is due to the high interest rate of the traditional mortgage pricing. Potential average annual loss for the next 10 years is 730, 000 volume and $15 billion Revenue. Because in the prior art mortgage principal is not insured, mortgage interest rates are high, which reduces volume and revenue.

FIG. 11B is a graph illustrating the relationship between mortgage interest rate and home purchases according to the prior art, and shows optimum revenue from the inverse relationship using estimated data (for year 2009). The historical analysis indicates that at an interest rate of 6% the number of mortgage originated is: 4.2M. It also indicates that this rate and volume produce the maximum revenue: $62B. Maximum revenue is due to home prices and the sensitivity of home demand to interest rates. 6% is the optimum interest rate, the affordability level that produces the greatest revenue.

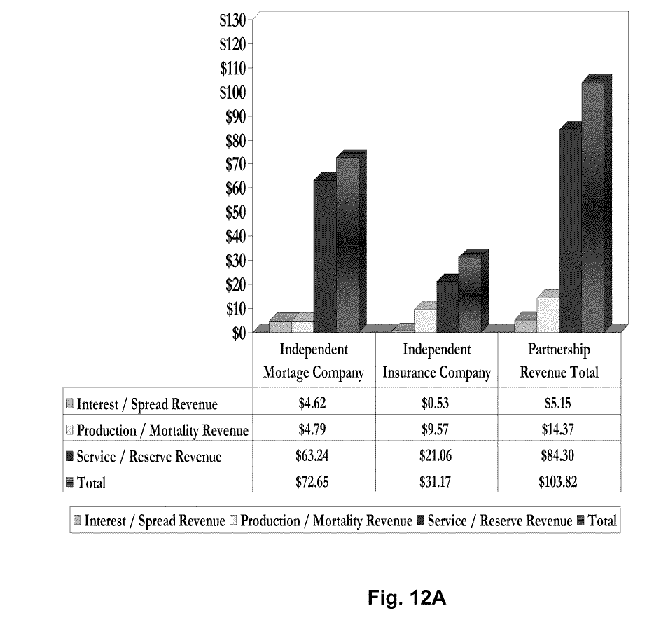

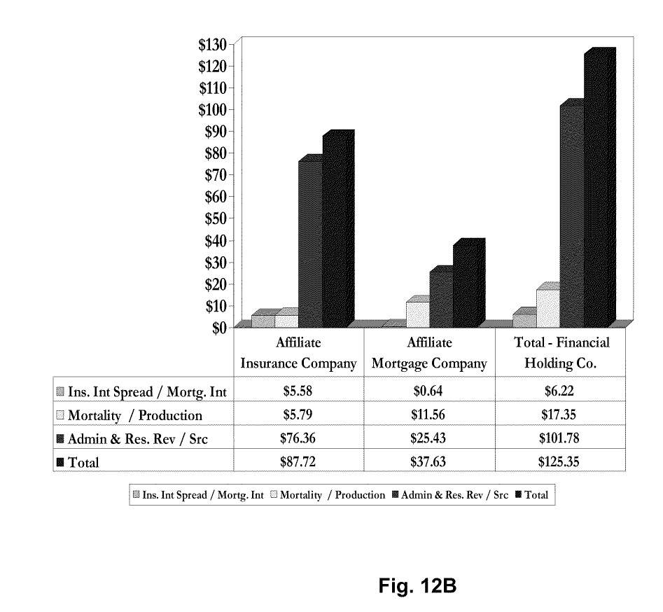

FIG. 12A is a bar graph illustrating insurance-funded mortgage product benefits by showing revenues for financial partners. FIG. 12B is a bar graph illustrating insurance-funded mortgage product benefits by showing revenues for the financial holding company. The two graphs illustrate a comparison of twenty year annual average revenues for partnership companies vs. affiliate companies. In accordance with a comparison of the graphs shown in FIGS. 12A and 12B, the financial holding company that has a banking and insurance company generates an average annual revenue of more than $20 billion more than a partnership relationship of two independent banking and insurance companies. The additional revenue is due, at least in part, to the ability of the financial holding company to withstand competitive pressures to operate at the optimum mortgage interest rate and optimum mortgage volume.

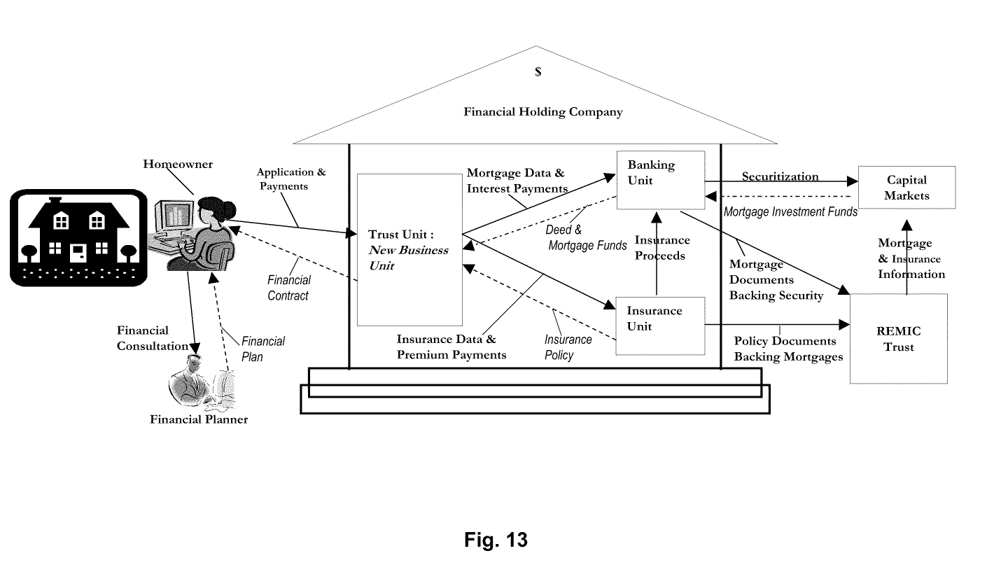

FIG. 13 is a figure illustrating an insurance-funded mortgage operation that combines mortgage and insurance operations. As shown in FIG. 13, insurance-funded mortgage operation is an end-to-end integrated mortgage and insurance processes.

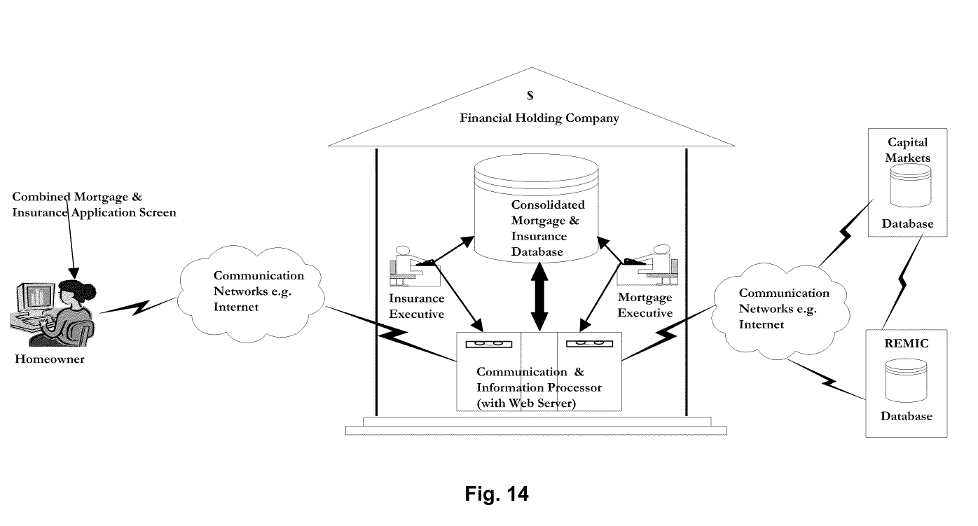

FIG. 14 is a figure that illustrates an insurance-funded mortgage information technology infrastructure that consolidates mortgage and insurance in a system application. As shown in FIG. 14, insurance-funded mortgage operation is an end-to-end integrated automation of mortgage and insurance processes.

Moreover, the consolidation of similar functional and support departments of the mortgage company and insurance company will reduce operation expenses consequently increasing the profits of the financial holding company. In addition to the $20 billion more annual average revenues, the financial holding company generates more expense reduction than a partnership relationship of two independent banking and insurance companies.

Thus, although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A system for reducing mortgage payments on a mortgage and operable in conjunction with an insurance policy, which is intertwined with the mortgage, the system comprising:
a first module including instructions that are operable on a processor readable medium that contains information regarding terms of a mortgage, wherein the terms include a principal amount of a mortgage, and an interest rate for the mortgage;
a second module including instructions that are operable on a processor readable medium that contains information regarding terms of a life insurance policy that is intertwined with the mortgage, wherein the terms of the insurance policy include information about proceeds of the insurance policy, the premium amount to be paid for the insurance policy, and the beneficiary of the life insurance policy; and
a tracking module including instructions that are operable on a processor readable medium that tracks interest payments made on the mortgage and associates therewith potential proceeds and/or value of the insurance policy, wherein the mortgage principal equals the life insurance death benefit and further wherein a cash value buildup over the term of the mortgage covers the mortgage principal during a predefined period of time and sufficient capital is accumulated to pay off the mortgage at the end of the mortgage term.

2. The system of claim 1, wherein the borrower periodically makes an interest payment on the mortgage to a mortgage company and makes an insurance premium payment on the insurance policy to an insurance company.

3. The system of claim 2, further comprising a right to foreclose on the property is provided in case of default of the mortgage interest payment or the insurance premiums payment.

4. The system of claim 2, wherein cash value accumulates from the life insurance premium payment, and interest is credited to the policy by the insurance company, and further wherein the borrow has an option to borrow against the cash value subject to underwriting.

5. The system of claim 4, wherein the property is sold before the end of mortgage term and the cash value accumulated in the policy is used to pay off the mortgage principal amount or is maintained for the benefit of a new lender.

6. The system of claim 4, wherein the cash value in the life insurance policy operates as a guaranteed amortization of the mortgage loan, but does not reduce the mortgage principal amount.

7. The system of claim 4, wherein the mortgage principal amount is paid using proceeds from the life insurance policy that include either the cash value at completion of the mortgage term or death benefits.

8. The system of claim 1, wherein the borrower transfers the insurance policy to a new lender in case the mortgaged property is refinanced.

9. The system of claim 1, further comprising a disability premium waiver that is extendable to cover interest payments on the mortgage.

10. The system of claim 1, further comprising a dividend option that is used to reduce payment on the life insurance premium or to increase cash value.

11. The system of claim 1, wherein a monthly required payment is calculated and compared with a payment for the life insurance premium to ensure adequate funding, and further wherein the required payment equals an amount of life insurance premium to be paid until mortgage term ends in order to accumulate cash value to pay off the mortgage principal at the end of term.

12. The system of claim 11, wherein if the required payment is greater than the premium due to investment losses or lower investment returns, the required payment instead of the premium payment.

13. The system of claim 1, wherein the life insurance policy cash value fluctuates in response to at least one investment over time, and further wherein a required payment ensures that proceeds of the insurance policy is sufficient to cover the principal balance on the mortgage.

14. The system of claim 1, wherein the life insurance is whole life, universal life, variable universal life, term or a combination of at least two of whole life, universal life, variable universal life and term insurance.

15. The system of claim 1, wherein a portion of the mortgage interest is invested into the policy and a portion of a down payment is invested into the policy.

16. The system of claim 15, wherein the portion of the mortgage interest is 0.125% or 0.25%.

17. The system of claim 1, further comprising a pool of people and funds that enables mortality savings for the insurance premium and compounded interest providing a terminal capital reserve.

18. The system of claim 17, wherein the pool is invested by a life insurance company to yield a return sufficient to pay the mortgage principal.

19. The system of claim 1, further comprising a life-insurance backed mortgage obligation security.

20. The system of claim 19, further comprising a securitized plurality of life-insurance backed mortgages obligation securities.

21. The system of claim 19, further comprising an aggregation of mortgage interest payments as a function of the securitized plurality of life-insurance backed mortgages obligation securities.

22. The system of claim 19, further comprising a classification of the life-insurance backed mortgage obligation security.

23. The system of claim 1, further comprising a protection strategy comprising a plurality of phases.

24. The system of claim 23, wherein the phases include a pre-acquisition phase, an ownership phase, a post-acquisition phase and a post-death phase.

25. The system of claim 1, further comprising a plurality of products, including a guaranteed insurance mortgage product, an endowment insurance mortgage product, an ordinary insurance mortgage product, a universal insurance mortgage product, a variable insurance mortgage product, a hybrid insurance mortgage and a term insurance mortgage product.

26. A method for reducing mortgage payments on a mortgage and operable in conjunction with an insurance policy, which is intertwined with the mortgage, the method comprising:
executing a first set of instructions operable on a processor readable medium that include information regarding terms of a mortgage, wherein the terms include a principal amount of a mortgage, and an interest rate for the mortgage;
executing a second set of instructions that are operable on a processor readable medium that include information regarding terms of a life insurance policy that is intertwined with the mortgage, wherein the terms of the insurance policy include information about proceeds of the insurance policy, the premium amount to be paid for the insurance policy, and the beneficiary of the life insurance policy; and
executing a third set of instructions that are operable on a processor readable medium that tracks interest payments made on the mortgage and associates therewith potential proceeds and/or value of the insurance policy, wherein the mortgage principal equals the life insurance death benefit and further wherein a cash value buildup over the term of the mortgage covers the mortgage principal during a predefined period of time and sufficient capital is accumulated to pay off the mortgage at the end of the mortgage term.
